(19) United States
(12) Patent Application Publication
(10) Pub. No.: US 2006/0265277 A1
(43) Pub. Date: Nov. 23, 2006

(54) Systems, methods, and programming for Internet games, including dating games

(76) Inventors: Vadim Yasinovsky, Newton, MA (US); Mitchell A. Russo, Marlborough, MA (US); Semyon Dukach, Brookline, MA (US)

Correspondence Address: Porter & Associates, 24 String Bridge S12, Exeter, NH, 03833, US

(21) Appl. No.: 11/371,202

(22) Filed: Mar. 7, 2006

Related U.S. Application Data
(60) Provisional application No. 60/659,040, filed on Mar. 7, 2005.

(51) Int. Cl. G06F 11/34

(52) U.S. Cl. 705/11

(57) ABSTRACT

Networked games, including network dating games are provided using instant messaging to provide a real time game and a game with a sense of presence from players and audience members. A dating game is provided where multiple men compete for a single woman.

### RELATED APPLICATION

This application is a continuation-in-part of and claims priority under 35 U.S.C. § 119(e) from the co-pending U.S. provisional application Ser. No. 60/659,040 filed by Mitchell Russo et al. on Mar. 7, 2005, entitled “Dating concept for the internet—combines skilled game playing, chance and appeal for both men & women”(hereinafter “The Provisional Application”). The Provisional Application is incorporated herein by reference in its entirety.

### FIELD OF THE INVENTION

The present invention relates to systems, methods, and programming for internet games, including dating games.

### BACKGROUND OF THE INVENTION

Since the origin of the Internet there have been many web sites dedicated to dating and helping people meet other people for purposes of friendship or romance.

In 2004, the online dating industry produced over $470 million in revenue, up 20% from the previous year. In the last couple of quarters, however, growth seems to be leveling off as the market is beginning to show signs of maturity and segmentation. On one end of the space, for older people serious about finding a spouse, E-Harmony requires a 400-question self description and True.com offers background checks to ensure single status among users. On the other end, the larger market of younger people who will remain single for longer remains wide open to whoever can actually make the process casual and fun.

Currently most of the dating web sites are based on users creating profiles of themselves, either by providing written or photographic descriptions of themselves or by answering sets of questions. In many systems users can browse such profiles that been categorized by such values as age, location, or interest.

On many current dating web site women are inundated with hundreds of messages from losers, which take too much work and frustration to sift through. On many such sites younger men often feel like they are lost in the shuffle. After spending time picking out a few women they think they really like, and carefully crafting them e-mails, they often do not hear back from anyone at all. This causes the men to instead write generic emails to much larger numbers of women, perpetuating the vicious cycle where each woman gets more useless emails she is unable process.

Traditional dating sites lack an element of coolness, and the younger generation avoids using them in order not to appear desperate, opting instead for the limited dating features of social networks like MySpace and Friendster.

### SUMMARY OF THE INVENTION

It is an object of the present invention to provide a form of Internet gaming which provides real-time response;

It is another object of the invention to provide a form of Internet gaming that gives users a sense of the presents of other players and/or audience members.

It is still another object of the present invention to provide a form of Internet dating which better accommodates differences between the way in which men and women approach dating.

It is yet another object of the present invention to provide a form of Internet dating which is entertaining.

It is still another object of the present invention to provide a form of Internet dating that women to receive input from others about their dating related choices.

It is yet another object of the present invention to provide a form of Internet dating that provides some of the same interest, enjoyment, and/or amusement as does flirting.

Instead of this mountain of useless contacts provided by man trandional dating sites, our invention has aspects that offer a dating site in which a woman only deals with men who are interested in her enough to pay to play for her. She receives just one or two emails from actual winners of a game she gets to design. The web site we have built based on our invention, GottaFlirt.com, isn't a database of profiles, but a fast paced, entertaining Flash-based game, where women choose the men they are interested in by rating the men's responses to 10 pre-selected questions. The questions can be of the woman's own making or can be chosen from a list of questions pre-written by comedy writers. The women pick the questions they find funny and/or enlightening, while also trying to filter out men they are not interested in. During the game, a woman can fudge the scores as she is rating the men's answers in real time, to help the man she likes win the right to contact her. Scoring from audience members provides the wisdom of crowds, helping the woman, know what others think about the contestants and their answers. In this game women truly have all the power, and this game doesn't try to hide it.

But beyond many embodiments of our invention, including that contained in the GoftaFlirt.com web site takes into account when the basic problems in most prior art dating sites. That is the profound difference between the way in which many men and many women view the opposite sex. Studies have indicated that when it comes to dating men tend to be attracted to women base first other looks, secondly based on their humor and mind, and third based on their emotional characteristics, whereas women are attracted to man based on the same factors in the exactly opposite order. That is they are attracted to man based first on their emotional characteristics, secondly their mind or sense of humor, and thirdly based on their looks. The embodiment of our invention attempts to reflects this difference.

According to a first aspect of the invention a computerized method is provided for conducting a real-time network-based dating game, where each of a plurality of players, including a host and a plurality of contestants, interact through a respective computer connected via a computer network. The method includes receiving input from a host representing a selection of one or more competitive challenges for said contestants to perform and using said selection in defining a game associated with the host. The method also receives input from potential contestant's indicating a selection to be contestants in a given game defined by a given host. During play of the game the method presents on each of said contestant's computers simultaneously both (a) each of the one or more challenges selected by the given host to be part of the given game; and (b) a user interface for receiving input from the contestant that enables the contestant to compete in the challenge. The method presents in real time on the host's computer the responses of the contestants to each challenge and receives any score input by the host in response to each of the contestants' responses. The method presents on the contestant's computer each of the other contestant's response to one or more of said challenges and the score the host has given each of the contestant's responses to said one or more challenges.

In some embodiments of this aspect of the invention the winner is select as a function of the scores given by the host to each of the contestants' responses to the one or more challenges and a reward is provided to the winner. The reward can include the provision of communication access to the host, such as the provision of the host's email address.

In many embodiment of the inventions the host is a female and the contestants are male. But in others the host could be a male and the contestants are female. In yet other embodiments the host and contestants can be of the same sex.

In some embodiments of the invention the challenges might involve intellectual challenges, such as solving puzzles, playing competitive video games, answering trivia questions, bidding, or answering personal questions.

In some embodiments where challenges are questions the questions and answers, or both, are in the form of spoken words and an audio representation of those spoken words communicated to other players in real time. In such embodiments where the contestants answer questions by voice, answers from other contestants can be prevented when an answer from one of the contestant is currently being received, so as to prevent the sound of questions from interfering with each other, and the host and other contestants hear the responses in real time.

In some embodiment where the challenges are questions the time for answering each question is limited to one minute or less.

In some embodiments of the invention input is received from one or more people over the internet concerning a game defined by a given host. Such input is used to schedule when the game defined by the given host is to be played; and the system

automatically causes the game to start at the scheduled time. In some such embodiments the input used for such scheduling includes input from the host selecting available time slots from the host. In other embodiments an interface is provided over the internet that lets people see information about one or more potential hosts, including photographs and the input used in scheduling includes rating input from people rating individual hosts.

Some embodiments of the invention provide an interface over the internet that lets people see information about one or more potential hosts; and information about when a game for a particular host is scheduled to be played.

Some embodiments of the invention provide a simultaneously viewable chat window on player computers so players can send and receive messages to and from said chat window during game. The chat window can provide text messaging, audio messaging, and/or video messaging. In some embodiments with such chat windows on player computers, information about the game, which can be similar to that presented to its players, is presented on one or more computers connected with said computer network that are associated with audience members, who are people other than players. In some such embodiments the presented to audience members includes said challenges, the contestants' responses, the host's scoring of said responses, and said chat window. This presentation of said information on said audience computers is performed simultaneously with its presentation to players; and the chat window allows audience members to interact with players and other audience members by sending and receiving messages.

In some embodiments of the invention said receiving of inputs from a potential contestant indicating a selection to be a contestant includes receiving input authorizing a financial payment to be made from said potential contestant's account as the price of playing said game. In some such embodiment the input authorizing a payment of the price of playing said game includes receiving competitive bids to be one of a limited number of contestants. In such embodiments the method includes providing on the potential contestant's computer an indication of the price that needs to be matched to win a right to be one of said contestants. It responds to input from the potential contestant authorizing the payment of a monetary amount sufficient to win the bidding by (1) enrolling the potential contestant as a contestant in the game; and (2) causing a transfer of said authorized amount from the potential contestant's account. The amount of this transfer for each player automatically transfers at least a portion of the money generated by the bidding of said winning contestants to said host or a recipient of selected by the host. For example, the host might select a favorite charity to which her portion of the bidding proceeds should be sent.

In some embodiments of the invention one or more of said players' respective computers are cell phones, and said computer network is a cellular phone network. Other wireless computing devices could be used to play the game as well.

In some embodiments of the invention each of said players' computers runs programming containing instructions for presenting a current game state to a user through said user interface. There are also instructions for responding to a user input received by said user interface during the current game state and for sending and receiving messages using the IM protocol. These include instructions for (1) generating IM control messages, which are IM messages that contain computer generated text in a form that can be parsed as coded instructions; (2) transmitting said IM control messages to another computer; (3) receiving said IM control message from one or more other computers; (4) parsing said message into one or more fields; and (5) using the values of said fields to control the program flow in the execution of said programming.

The programming also includes Instructions for causing the user input made in response to a current game state on one computer to cause the generation and transmission of said IM control messages; and receipt of said IM control messages from one or more other computer to cause automatic changes in the game state on the receiving player computer.

In some such embodiments the programming running on each of said players' computers includes an IM client for sending and receiving said IM control messages; and an IM server program is run on a server computer. This server computer maintains a representation of a current game state in the server computer. It also responds to changes in said server's representation of the current game state by generating and transmitting over said network to the IM clients on one or more of said player computers IM control messages that cause said automatic changes in the representations of current game state on said player computers. The server also receives IM control messages generated by said IM clients; and responds to values of fields parsed from said received IM control messages by changing said server's representation of the current game state.

According to another aspect of the invention method for conducting a real-time network-based game is provided. In this method each of a plurality of players and each of a set of audience members interact through a respective one of a set of computers that are connected via a computer network. The method runs user interface programming on each of said player's computer that provides output to and receives input from players of the game. It also runs user interface programming on each of said set of audience member. The user interface programming provides a real time representation of the output and input to one or more of said players; and it receives input from one or more audience members; and automatically determining the course of said game in response to said input from both said players and audience members.

In some embodiments where the audience provides scores and where the game includes a host and a plurality contestants, the user interface programming on the plurality of contestant computers simultaneously presents each of the one or more competitive challenges selected by the host and received player input generated in response to said challenge. In such embodiments the user interface programming on the host's computer presents in real time the responses of the contestants to each challenge and receives a score from the host in response to each of the contestants' responses. The automatic determining of the course of said game automatically combines both said scores from the host and scores from the audience in determining the winner of the game. In some such an embodiments the challenges are individual questions, said responses from the players are answers to said individual questions; and scores from both the host and said audience members are scores made in response to said answers to individual questions.

Another aspect of the invention also involves a method performed by computing machinery of conducting a real-time network-based game where each of a plurality of players, including a host and a plurality contestants, interact with a respective one of a set of computers that are connected via a computer network.

This method receives from the host a selected set of questions. After receiving these questions it sequentially performs a question cycle for each of said questions. The question cycle includes: (1) presenting the cycle's question to each contestant and receiving a response to said question; (2) presenting in real time to the host and all other contestants each of said responses, with an identification of the contestant who made each response; (3) receiving from the host a score for each of one or more of said responses, which score is associated with both the response and contestant who give the response; and (4) for each of said scores received from the host, presenting to all players a presented score, determined as a function of said score received from the host, which presented score indicates the contestant with whom its response is associated. At the completion of the question cycles the method calculates a total score for each contestant as a function of the combination of scores given to the contestant's responses by the host, and it uses the total scores calculated for all contestants in selecting a winner of the game. The method presents to all players the total scores of the contestants and an indication of the winner of the game.

In some embodiments of this aspect of the invention one or more audience members each have a computer connected via said network to said player computers, and thAnd cakes and reducing here we are doing thee presenting of a question cycle's question, the responses to said question, said presented scores, and the indication of the winner, are also presenting to said audience members. Such embodiments further receive, during each question cycle, scores from individual audience members for individual responses made by contestants; and combine scores for a given response from audience members with the score for the same response from the host to calculate the presented score for that response.

According to another aspect of the invention another computerized method for conducting a network-based dating game is provided. This method includes (1) running user interface programming on the host's computer that contains instructions for allowing the host to select a one or mores challenges for contestants; (2) running user interface programming on a potential contestant's computer that contains instructions for: (a) presenting information, including one or more pictures of the host; (b) responding to a selection to pay the price to play a game before the host by initiating: (c) a transfer of funds from an account associated with potential contestant; and (d) selection of said potential contestant as a contestant for the game before the host.

The method further includes (3) running user interface programming on each contestant's computer that contains instructions for: (a) presenting each of said challenges selected by the host for his/her game to each of the contestants; (b) receiving responses from the contestant in response to each challenge; (c) presenting responses from a plurality of said contestants to an individual challenge and the scores generated for such responses; and (d) indicating as the winner of the game the contestant with the best overall score.

According to another aspect of the invention another computerized method for conducting a real-time network-based dating game is provided. This method runs user interface programming on each of a plurality of potential contestant's computers that containing instructions for (1) presenting information about the host; (2) receiving input indicating a potential contestant has selected to be a contestant in a game for the host; (3) running user interface programming on each of said contestant's computers containing instructions for: (a) representing the current state of a game; and (b) receiving input from the contestant that alters the contestant's in the current state the game; (4) running on the host's computer user interface programming including instructions for: (a) representing the current state of the game; and (b) presenting an indication of the relative performance of multiple contestants in the game at successive times in the progress of the game, including, when the game is over, which of the contestants is the winner.

In some embodiments of this aspect of the invention the—information about the host is a one or more pictures. In some embodiments men pay for the chance to compete, including bidding to compete. In some embodiments, the competition of the game includes a bidding war and/or the men can compete by purchasing gifts for the woman or an entity she choses.

According to another aspect of the invention programming is provided for a networked computer game recording in machine readable memory, including player programming for use in a given player's computer during a real-time distributed network game, where each of a plurality of said player computers interact over a computer network. The player programming comprising instruction for: (a) maintaining a representation of a current game state in the player computer; (b) generating and transmitting over said network to other computers involved in the running of the game IM control messages that are IM messages containing computer generated text in a form that can be parsed into one or more fields having values that can be used to alter the execution flow in the running of programming used by computer involved in the game; (c) receiving from other computers over the network said IM control messages involved in the game; (d) parsing said received IM control messages into said one or more fields; (e) responding to the values of fields parsed from received IM control messages by automatically changing the player computer's representation of the current game state; (f) presenting to the player a representation of the current game state; (g) responding to player input made during the current game state by generating an IM control message and transmitting it over said network to another computer involved in said game.

In some such embodiments, said player programming includes an IM client for said sending and receiving of IM control messages; and said programming for a networked computer game further includes IM server programming for use on a server computer. The IM server programming includes instructions for: (a) maintaining a representation of a current game state in the server computer; (b) responding to changes in said server's representation of the current game state by generating and transmitting over said network to the IM clients on one or more of said player computers IM control messages that cause said automatic changes in the representations of current game state on said player computers; (c) receiving IM control messages generated by said IM clients; and (d) responding to values of fields parsed from said received IM control messages by changing said server's representation of the current game state. In some such embodiments, the IM server uses the Jabber IM protocol.

### DESCRIPTION OF THE DRAWINGS

These and other aspects of the present invention will become more evident upon reading the following description of the preferred embodiment in conjunction with the accompanying drawings, in which:

FIG. 1 is a is a schematic representation of a system for playing a networked dating game according to the present invention;

FIG. 2 is a representation of some of the important web pages contained on the web site shown in the server computer of FIG. 1;

FIG. 3 is a schematic representation of the contents of the database used by the server computer shown in FIG. 1;

FIG. 4 is a high-level representation of a game server located on the server computer of FIG. 1;

FIGS. 5A through 5C provide a simplified pseudocode representation of the programming contained in the IM server contained within the server computer of FIG. 1;

FIGS. 6A and 6C are high-level pseudocode representations of the programming contained on the flash clients that are downloaded by the server computer to the client computers shown in FIG. 1;

FIG. 7 is a screenshot of the home page/game page of the web site represented in FIG. 2 at a time when a game is not currently being play;

FIG. 8 is a screenshot of the sign-in page of the web site represented in FIG. 2;

FIG. 9 is a screenshot of the registration page of the web page represented in FIG. 2;

FIG. 10 is a screenshot of the profile page of the web page represented in FIG. 2 before a user has entered any information into it;

FIG. 11 is a screenshot of the profile page after a user has entered information into it;

FIG. 12 is a screenshot of the “my game” page of the web page represented in FIG. 2;

FIG. 13 is a screenshot of the “review game” page of the web page represented in FIG. 2, shown after a registered female user first selects to review a given one of her games;

FIG. 14 is a second screenshot of the “review game” page of the web site represented in FIG. 2, shown after a user has selected to review a particular question in the game;

FIG. 15 is a screenshot of the “change game” page of the web site represented in FIG. 2, after that page has been selected from a “review game” page in the state shown in FIG. 14;

FIG. 16 is a screenshot of the “change game” page that results if the user presses the next question button shown in FIG. 15;

FIG. 17 is a screenshot of the “my token” page of the web page represented in FIG. 2;

FIG. 18 is a screenshot of the “stuff” page of the web page represented in FIG. 2;

FIG. 19 is a screenshot of the “invite friends” page of the web site shown in FIG. 2;

FIG. 20 is a screenshot of the “do you want to play?” scene presented by the flash clients of FIG. 1 to registered male users during the sign-up period at the start of a game;

FIG. 21 is a screenshot of the “you are accepted” scene presented by flash client's to registered male users who have been accepted as contestants for a game;

FIG. 22 is a screenshot of the “we are waiting for the players” scene presented by flash clients to the host, audience members, and all male contestants who have already received presentation of the “your are accepted” scene shown in FIG. 21;

FIG. 23 is a screenshot of the “question cycle” scene, immediately after the first question cycle for a game has started;

FIG. 24 is a screenshot of the same “question cycle” scene after three of the contestants have selected answers to the first question and the host has provided scores in response to them;

FIG. 25 is a screenshot of the “question cycle” scene, immediately after the second question cycle for a game has been started;

FIG. 26 is a screenshot of the non-host score-finalization-period scene that is shown on the computers of contestants and audience members during the score finalization period during which the host can alter and finalize her scoring;

FIG. 27 is a screenshot of the host's score-finalization-period scene shown on the computer of the host during the score finalization period to enable her to alter contestant scores for answers to individual questions;

FIG. 28 is a screenshot of the winner-announcement scene shown on the computers of all flash clients connected to the game at its end to indicate which contestants won;

FIG. 29 is a high-level representation of a web page that can be included in some embodiments in the web site represented in FIG. 2 to enable users to select to see replays of previously played games;

FIG. 30 is a representation of data structures that can be added to the database represented in FIG. 3 in order to support the replay of a previously played game selected by a user, such as through the web page shown in FIG. 29;

FIG. 31 is a high-level pseudocode representation of the changes that would be made to an IM server of the type represented in FIG. 5 to enable it to perform game replays, such as those selected through the web page shown in FIG. 29.

It should be understood that the foregoing description and drawings are given merely to explain and illustrate and that the invention is not limited thereto except insofar as the interpretation of the appended claims are so limited. Those skilled in the art who have the disclosure before them will be able to make modifications and variations therein without departing from the scope of the invention.

### DETAILED DESCRIPTION OF PREFERRED EMBODIMENTS

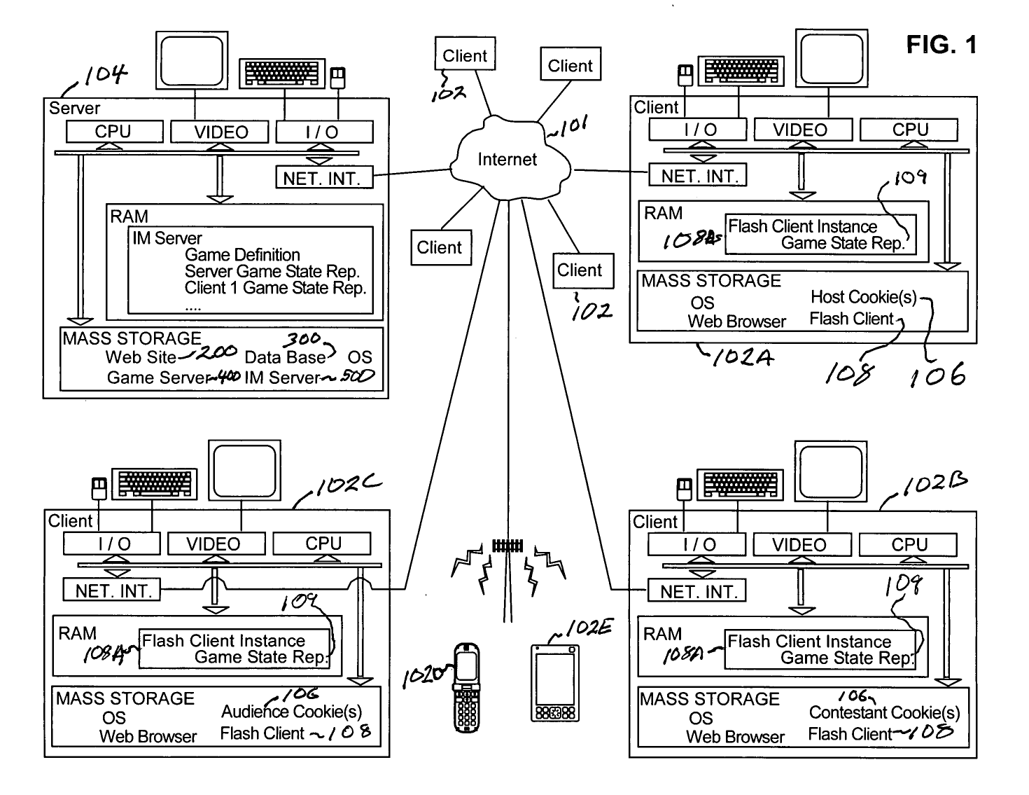

FIG. 1 is a highly schematic representation of the hardware and software of one embodiment of the invention's Internet game innovation. This embodiment is for a game in which a female host gets to define a game comprised of a plurality of personal questions. Male contestants can select to compete in her game and answer her questions. People beside the host and the contestants can view the game. The host and members of the audience registered with the game system, can score the individual answers of male contestants, with the scoring by the woman being more heavily weighted. The winner is selected based on which contestant has the best overall score.

Since the game is an Internet game the host, the contestants, and audience members perceive it and interact with it through respective computers 102 which are connected over an Internet 101. The client computers can be standard desktop, laptop, and/or tablet computers, or any other type of computer capable of interacting with the game system. This can include a cell phone 102D, or a personal digital assistant 102E.

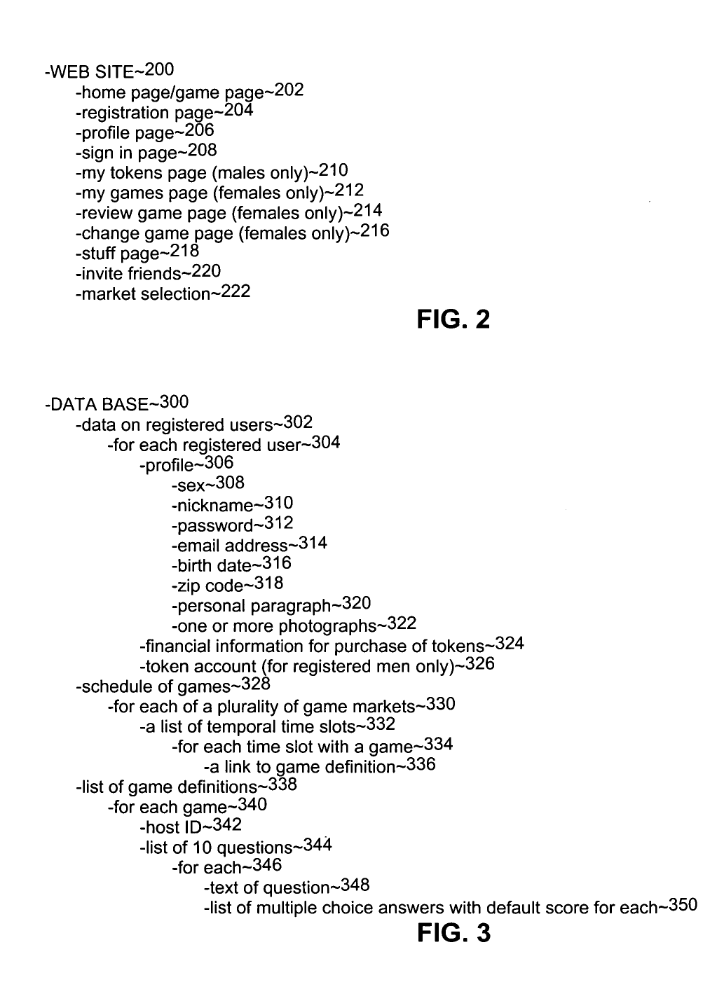

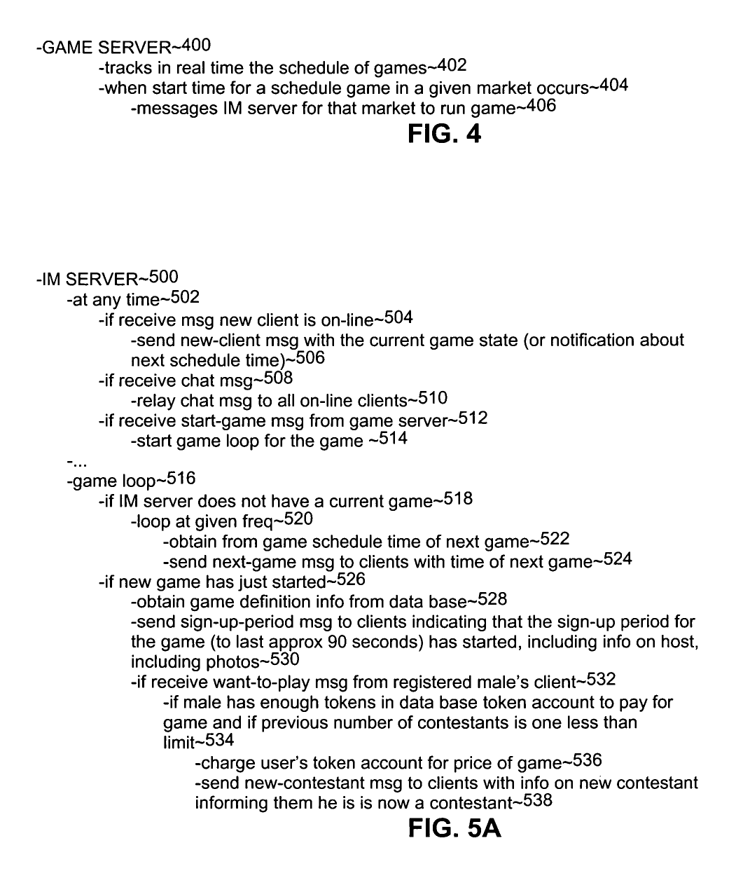

The embodiment of the invention in FIG. 1 is a client-server embodiment in which one a more server computers 104 provide a web site 200. As will be described below a greater detail with regard to FIG. 2 and screenshots from the web site, this web site lets users register with the game system, sign-in, define a profile of themselves, buy the tokens used by male contestants to purchase rights to purchase play in games, and allows hosts to define, change, and schedule games.

Another important function provided by the web site 200 results from the fact that one of its pages, the game page 202 listed in FIG. 2, is a Flash movie. A flash movie can be a program, capable of providing multiple images, including animation, and sounds, that can be programmed to be interactive. Flash movies are created using the Flash software that is sold by Adobe Systems Incorporated, 345 Park Avenue, San Jose, Calif. 95110-2704.

When a client computer requests a web page such as the game page that contains a flash movie, that movie is downloaded to run on the client. The particular flash movie on the game page of the web site 200 functions as a client program 108 when downloaded to the client computers 102 shown in FIG. 1. These flash clients 108 have been programmed in Flash's Acuscript programming language to generate and parse IM text messages in an XML form that lets them to encode information that can be used to enable an IM server 500 located on the server computer 104 to control the progress of a game by sending encoded IM control messages and receiving such messages from the flash clients 108.

In the embodiment of FIG. 1, the flash clients 108 downloaded to a game's host, contestants, audience members, and to any other persons who access the game page, all contain identical programming. But the operation of the flash clients varies as a function of information sent down to the flash clients by the server 104. Such behavior-differentiating information includes the value of cookies that are downloaded to the client computers by the server 104 as a result of whether or not the client's user is registered with the server's database, is a male or female, and has paid to participate in a particular game.

When an instance 108A of a flash client is executed on a client computer, it stores a game state, which includes not only its role in the game, as reflected by the cookies it has been sent by the server 104, but also data 109 it stores to represent information about the current state of the game.

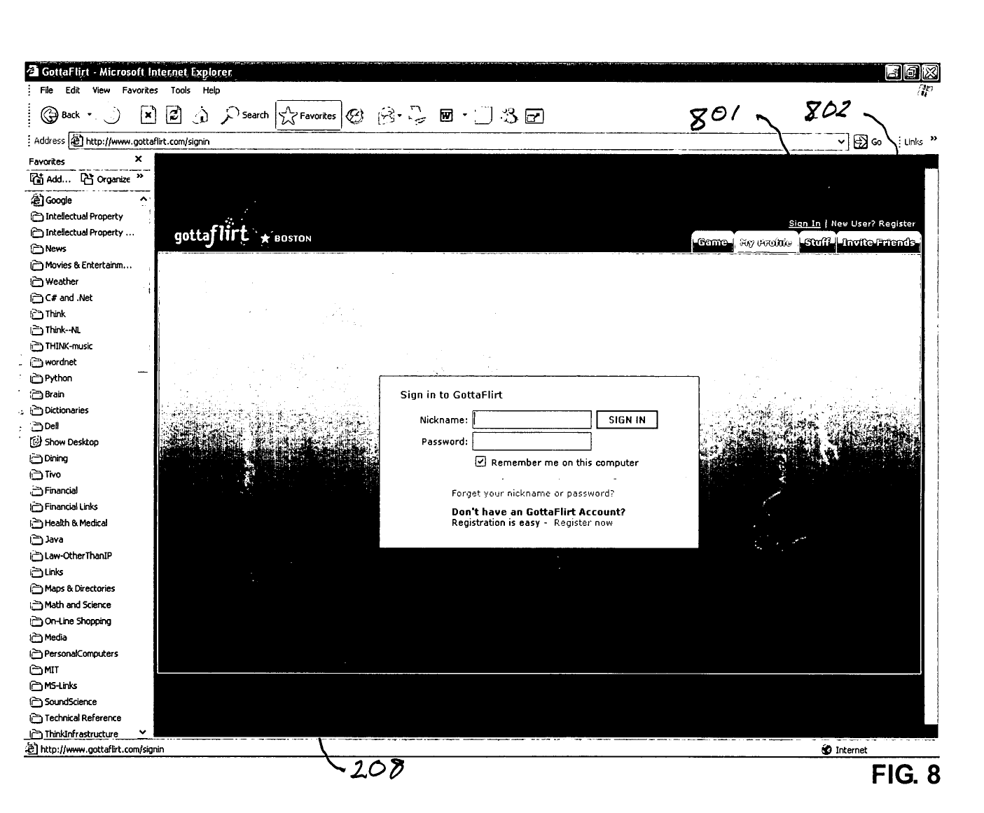

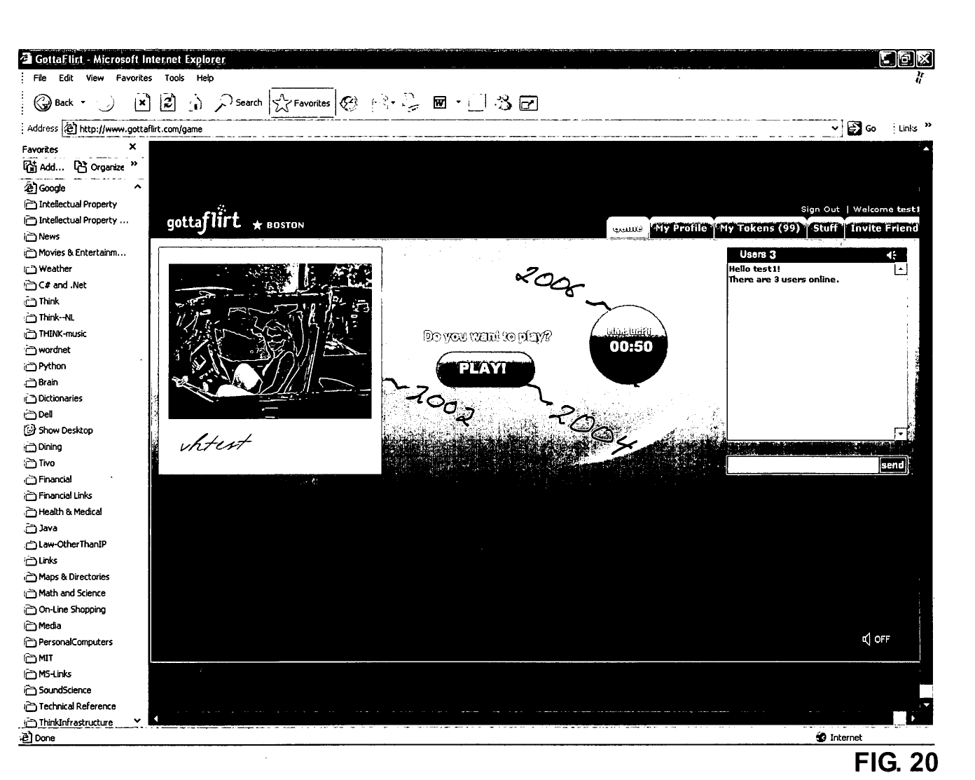

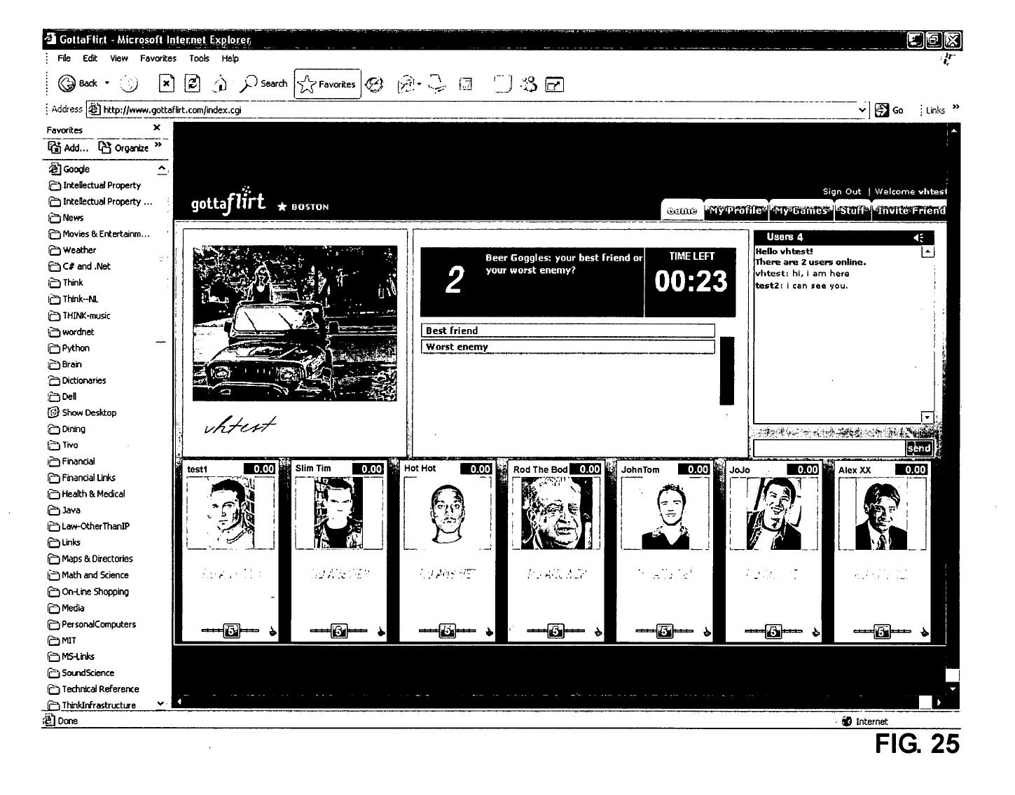

FIG. 2 lists some of the web page that reside on the web site 200. As stated above this includes the “game” page 202. The game page is used as the homepage of the web site. Images produced by the flash movie on this web page are shown in FIG. 7 and FIGS. 20 through 28. When a user first goes to the web site 200, they will either see an image similar to that shown in FIG. 7, which indicates the time of the next game if no game is currently being played, or screens like that shown in FIGS. 20 through 28 if a game is currently being played.

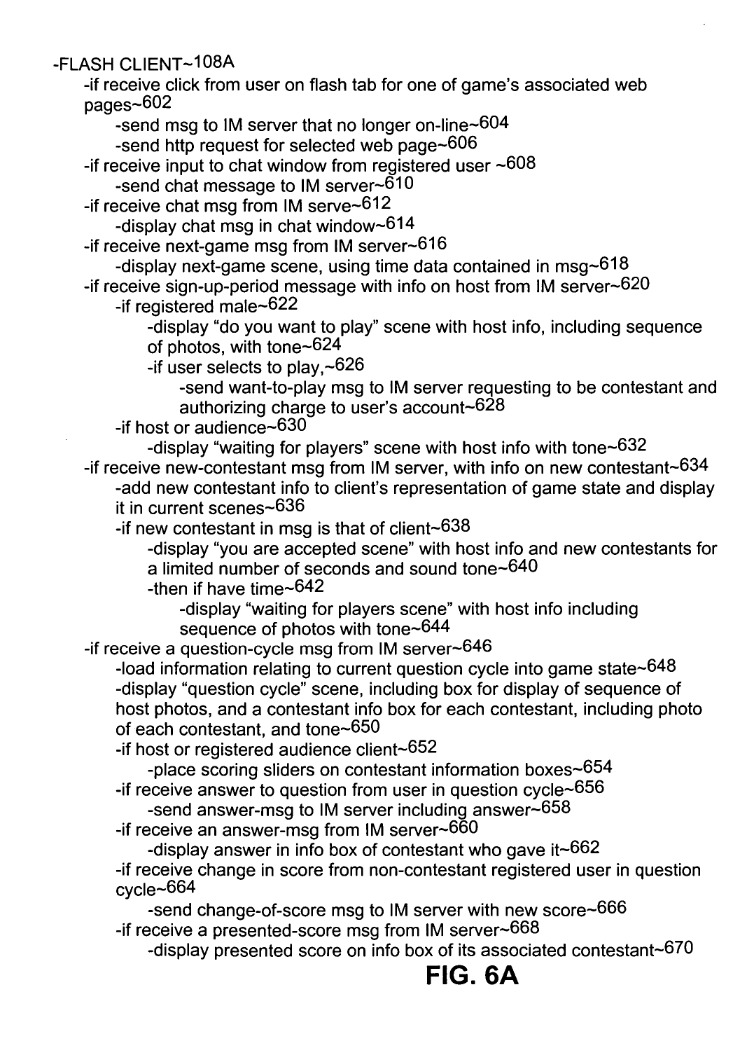

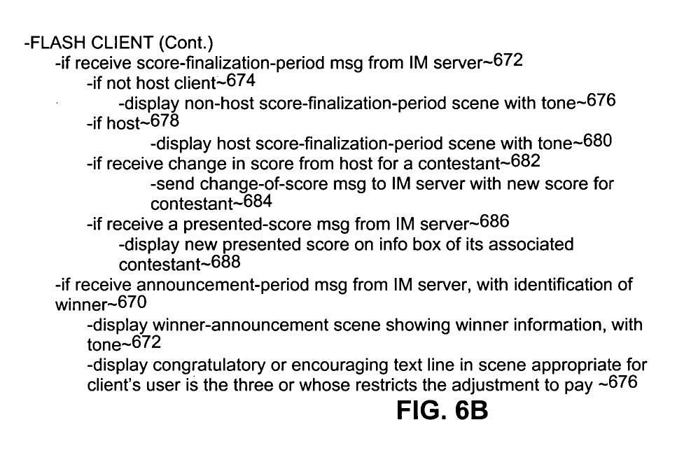

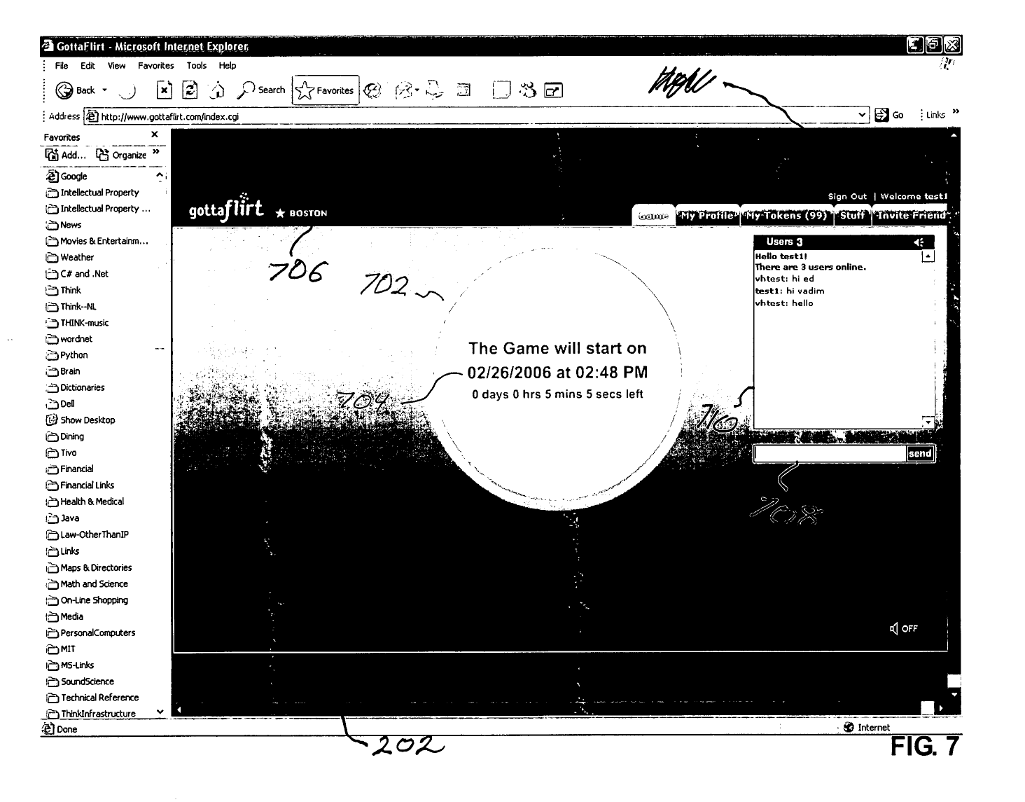

The flash client 108A includes programming 602 through 606 that responds to clicking on any of the links in the game page 202 that connect to other pages of the web site 200 illustrate in FIG. 2. These functions respond by causing the browser of the client computer on which the flash client is executing to send an http request to the web site 200 for the selected Web page. This causes the flash client to stop executing, at least temporarily. That is why step 604 of the flash clients, shown in FIG. 6A, sends a message to the IM server 500 that runs the operation of games, to inform it that the user's computer is no long connected to participate in any game.

The web site 200 also includes a sign-in page 208, shown in FIG. 8, which lets a previously registered user sign in to the web site by supplying his or her the name and password. If the sign-in is successful, the web site will send cookies to the user's browser that indicate if the user is a registered user, the user's ID, and whether the user is a male or woman. The sign-in page is accessed by clicking on the sign-in link 801, labeled in FIG. 8, on a game page or other page of the web site.

If the user has not previously registered, he or she can do so by clicking on the registration link 802, shown on one of the site's pages, as indicated in FIG. 8. This will take the user to the web site's registration page 204, shown in FIG. nine. There the user can enter information required for registration, such as their sex, nickname, password, and e-mail. Once they have entered this information they can click the register button, which causes the server computer to attempt to register the user and enter the registration information into fields 308, 310, 312, and 314 of the database 300, shown in FIGS. 1 and 3.

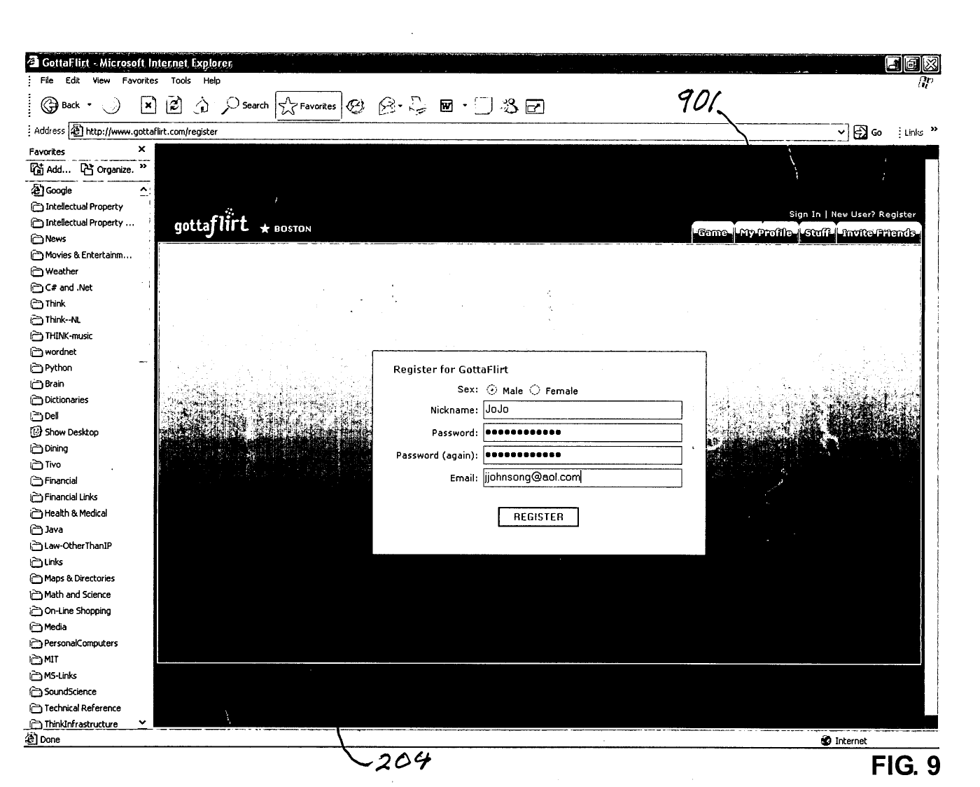

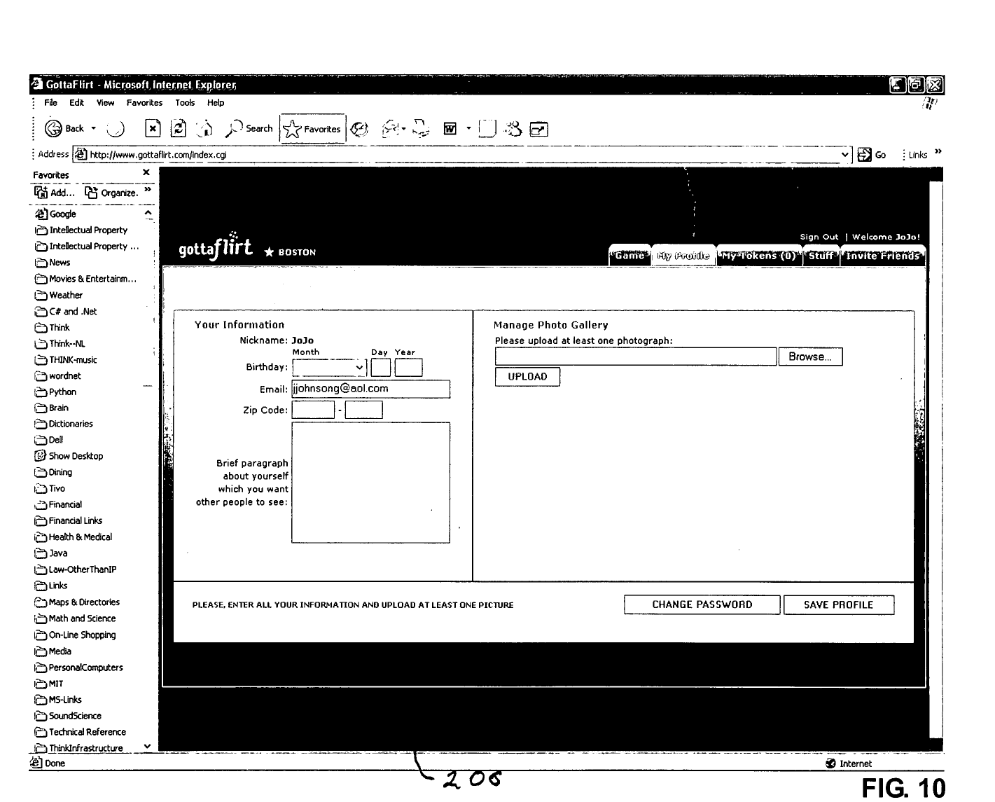

If the user successfully registers in response to a clicking of the register button on the registration page shown in FIG. 9, of if the user clicks the “my profile” link 901, on one of the site's pages, as shown in FIG. 9, he or she will be taken to the profile page 206 shown in FIG. 10. This page contains controls for allowing a registered user to enter additional information such as their birth date, their ZIP code, a brief personal paragraph, and a set of up to five photographs of themselves for use by the system. This information is stored in the database 300, shown in FIG. 3, in locations 316 through 322.

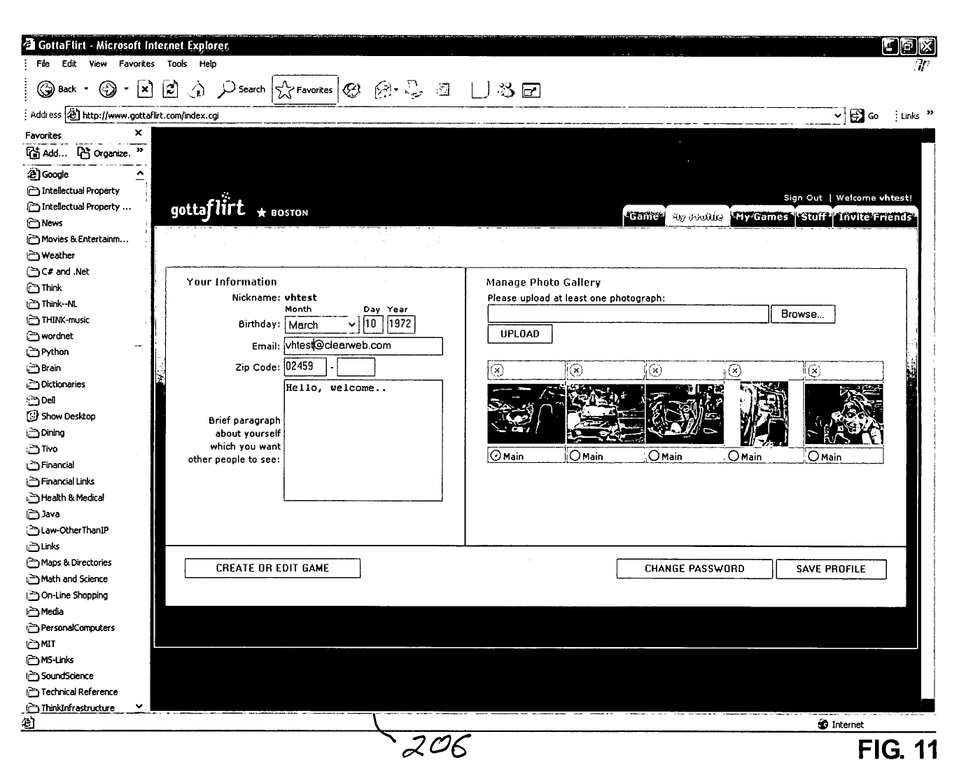

FIG. 11 illustrates the profile page 206 after a user has entered information into it.

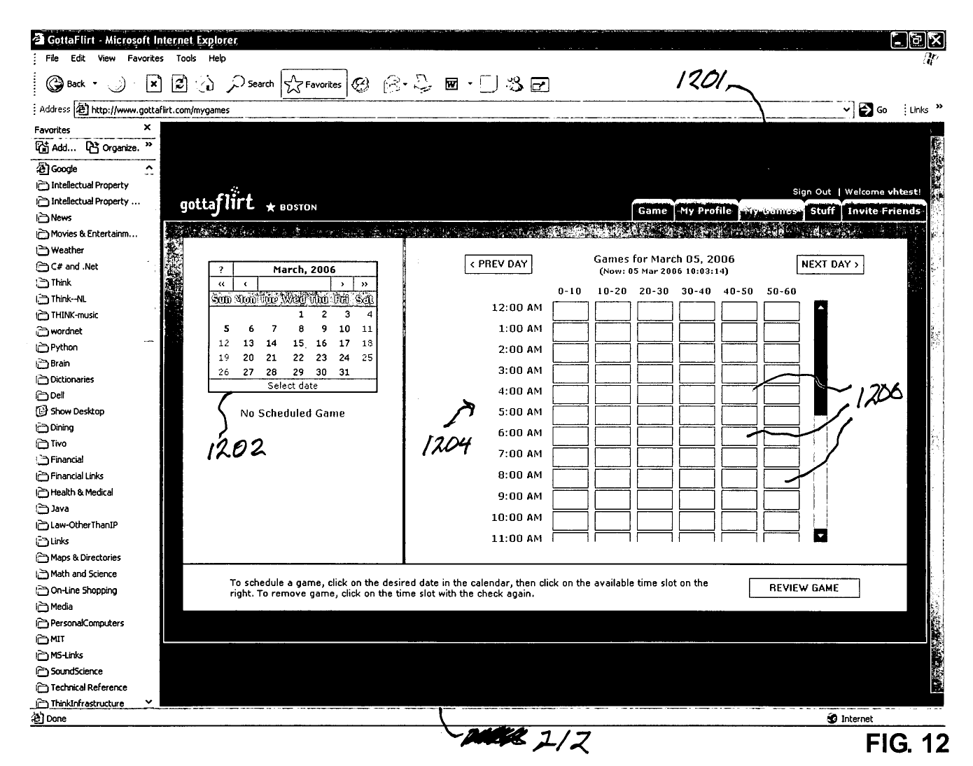

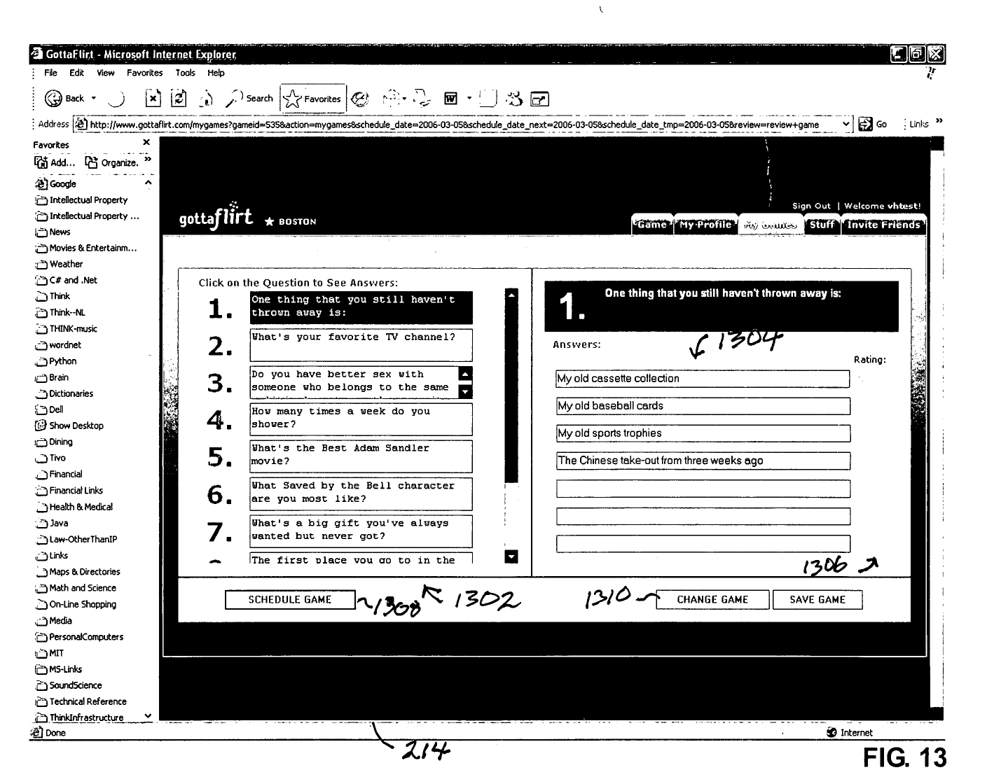

FIG. 12 illustrates the “my game's page” 212 which is accessed by clicking a page's “my games” tab 1201, shown in FIG. 12. This page is only available to registered female users. It contains a calendar control 1202 that allows the female user to navigate to a selected day, and it includes a day-view interface that allows the user to see at what times during the currently selected day's time slots are available for the scheduling of the game and in which the user, herself, has a scheduled game. The day-view interface allows the female user to select a time slot buttons 1206 on which either no game is scheduled or on which one of her games is scheduled. In FIG. 12 none of the time slot buttons are scheduled. If any of them were scheduled, they would bear an indication of whether they were scheduled by the current female user or another registered female.

If the user clicks the “review game” button, the web site takes her to the “review game” web page 214, from which the user can review and edit a previously defined game, or can defined a new game.

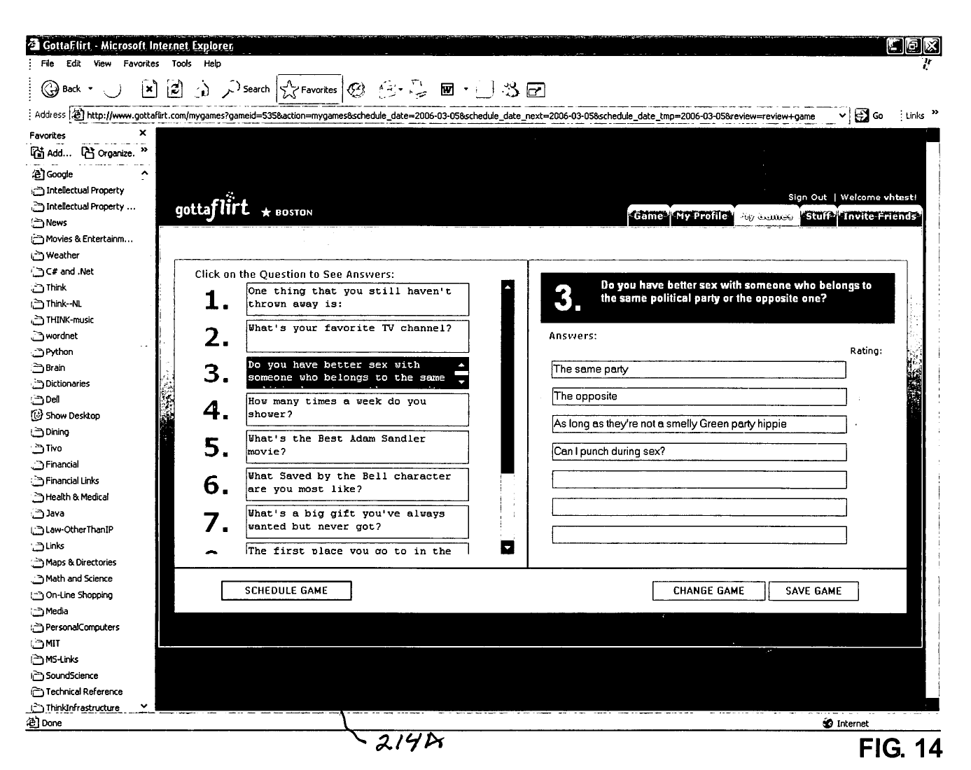

FIG. 13 illustrates the “review game” page 214 of the web site. On the left-hand side 1302 it displays a scrollable list of the 10 questions in the female user's current game, with the currently selected question highlighted, as is question 1. in FIG. 13. The predefined multiple-choice answers for the currently selected question are shown in column 1304 and the predefined default score for each such an answer will be shown in the column 1306. The user can scroll to and click on any of the 10 questions to cause its predefined answers to be shown in column 1304. For example, if the user clicked on question three the “review game” page would have the appearance shown in FIG. 14.

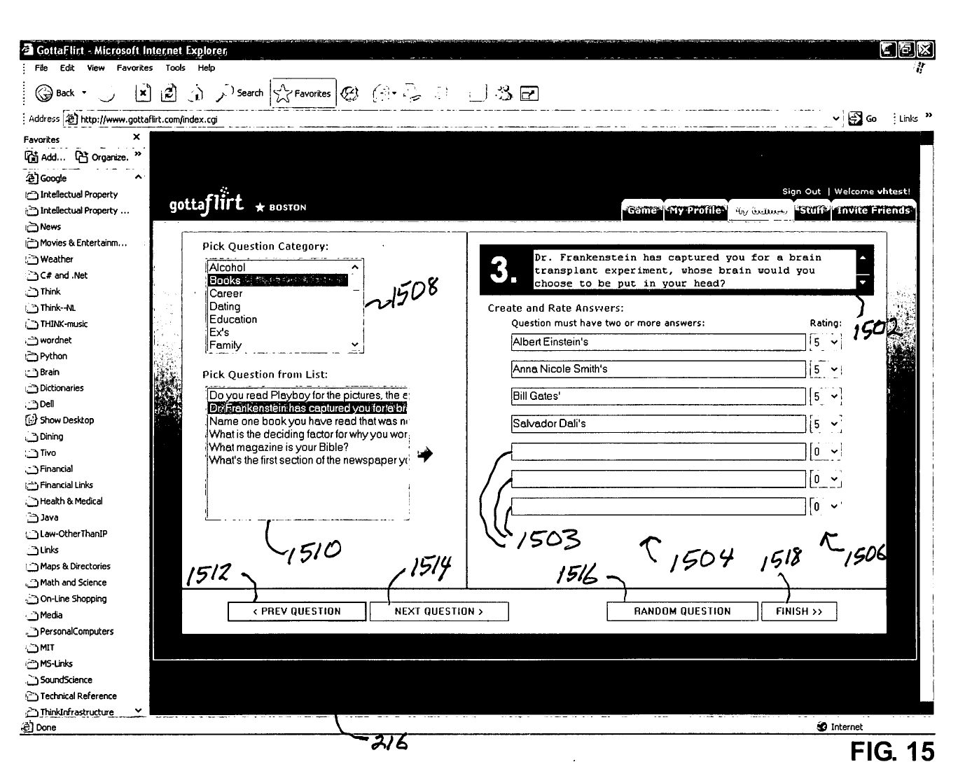

The “review game” page includes a button 1308 shown in FIG. 13, which allows the user to schedule became shown it in that page by going to be “my games” scheduling page shown in FIG. 12. The “review game” page also includes a “change game” button 1310 which if clicked takes the user to the “change game” page 216 shown in FIG. 15.

When the user enters the change game page from the review game page the question that was previously selected in the review game page is shown in a scrollable edit box 1502. The user can use this edit box to either partially or totally change the text of the currently selected question. A set of edit boxes 1503 are arranged in a column 1504 in which the current, if any, previously defined multiple-choice answers for the current question are displayed. The user can also partially or totally change the text in any of these edit boxes. In the column 1506 there is located a numerical selection control for associating a value between zero and 10 with each of the predefined multiple-choice answers defined in column 1504.

To help the user, a pick question category list box 1508 is included on the page which allows the user to selected a category of questions. If the user selects such a category a set of predefined questions are displayed in the list box 1510. If the user clicks on such a predefined question its text will automatically be placed in the edit box 1502. The female is then free to either use the question as is, or edit it as she likes.

A “previous question” button 1512 and a “next question” button 1514 candy click to cause either the previous oil in next question in the game to be displayed in edit box 1502 with its multiple-choice answers in edit boxes 1503. A “random question” button 1516 can the pressed to cause a random one of the predefined questions to have its text and multiple-choice answers inserted, respectively, in edit boxes 1502 and 1503. If the finish button 1518 its pressed, the user will be notified if the game has not had all 10 questions properly defined, and will be given an option to save the current game in the database list of game definitions 338 shown in FIG. 3.

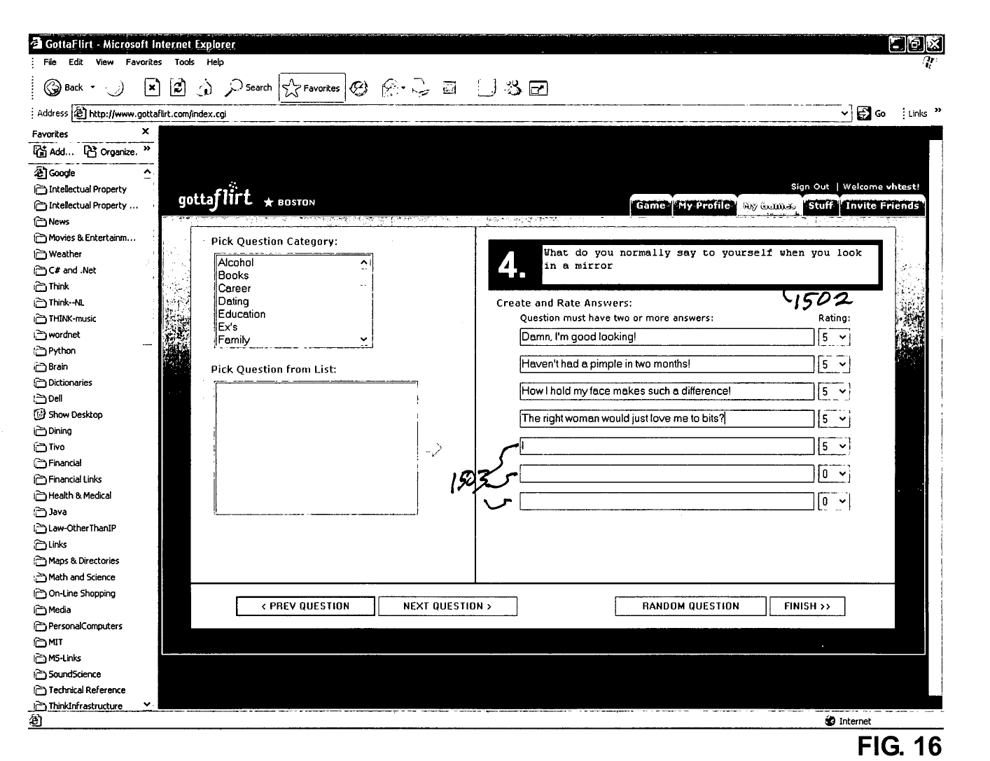

FIG. 16 illustrates what would happen if the user who entered they seem shown in FIG. 15 from that shown in FIG. 14 pressed the next question button 1514 in FIG. 15 and then proceeded to type new text in the question the edit box 1502 and in the multiple-choice answer edit boxes 1503.

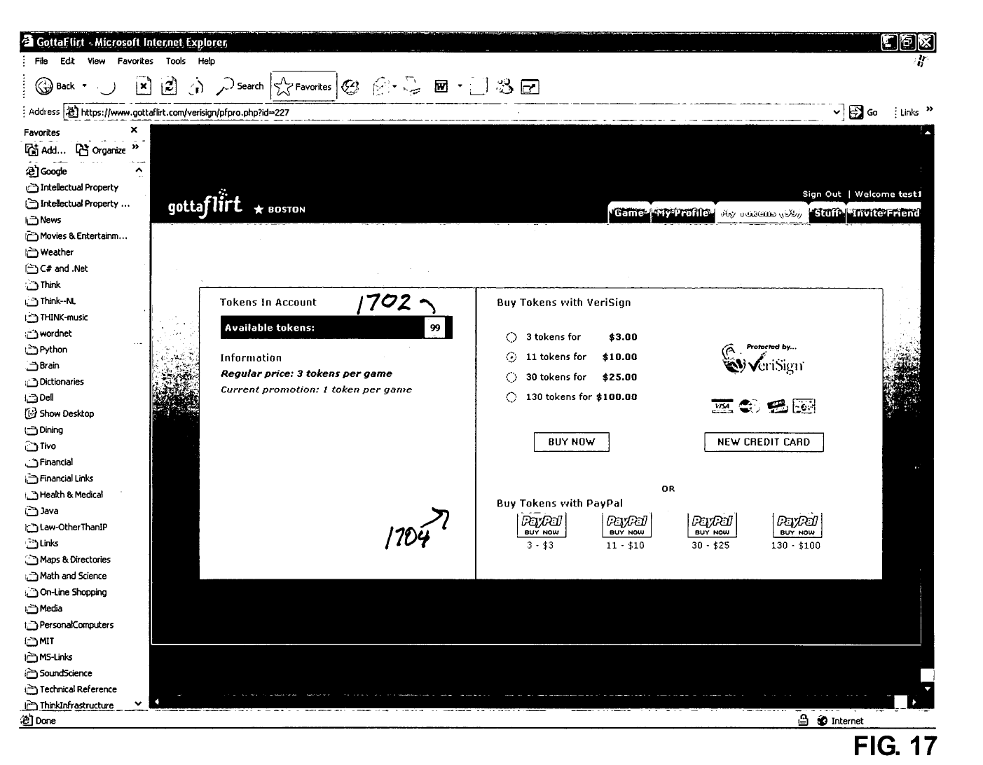

FIG. 17 illustrates the “my tokens” page 210 that can be accessed by a registered males to view their token account and to purchase new tokens. It includes a current token number indicator 1702 which shows how many tokens the male user currently has in his account stored in the token account 326 of FIG. 3 and a left-hand portion 170 before that allows the user to purchase new tokens using either credit card or PayPal.

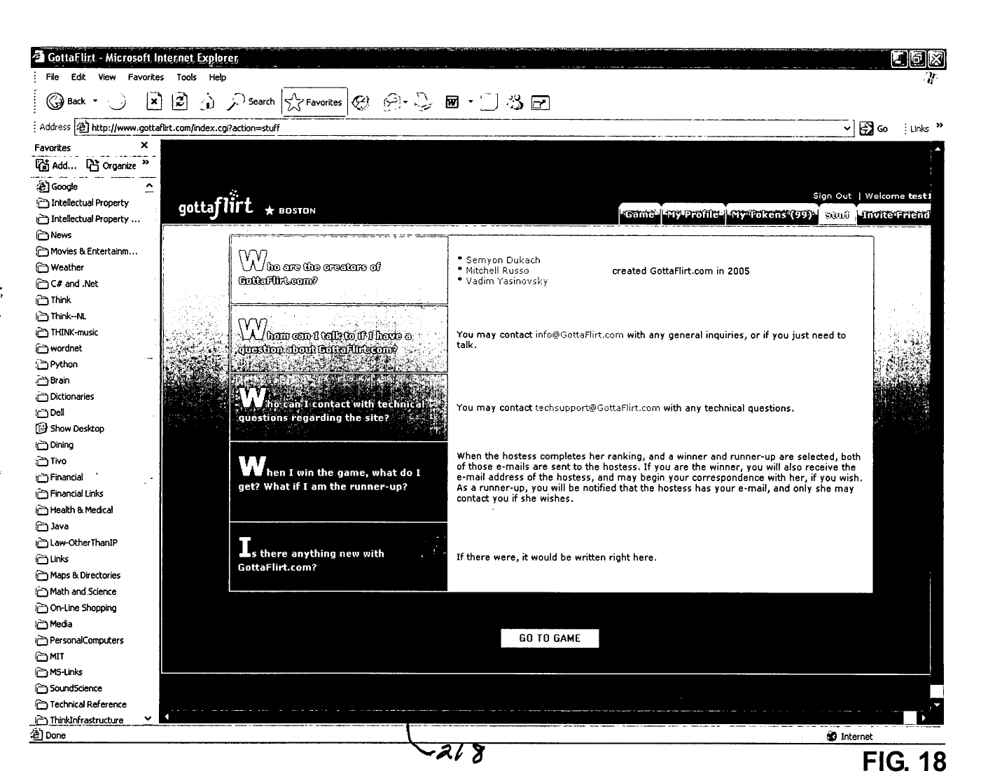

FIG. 18 illustrates the “stuff” page 218 of the web site 200. This page includes miscellaneous information such as contact information, including contact regarding technical questions.

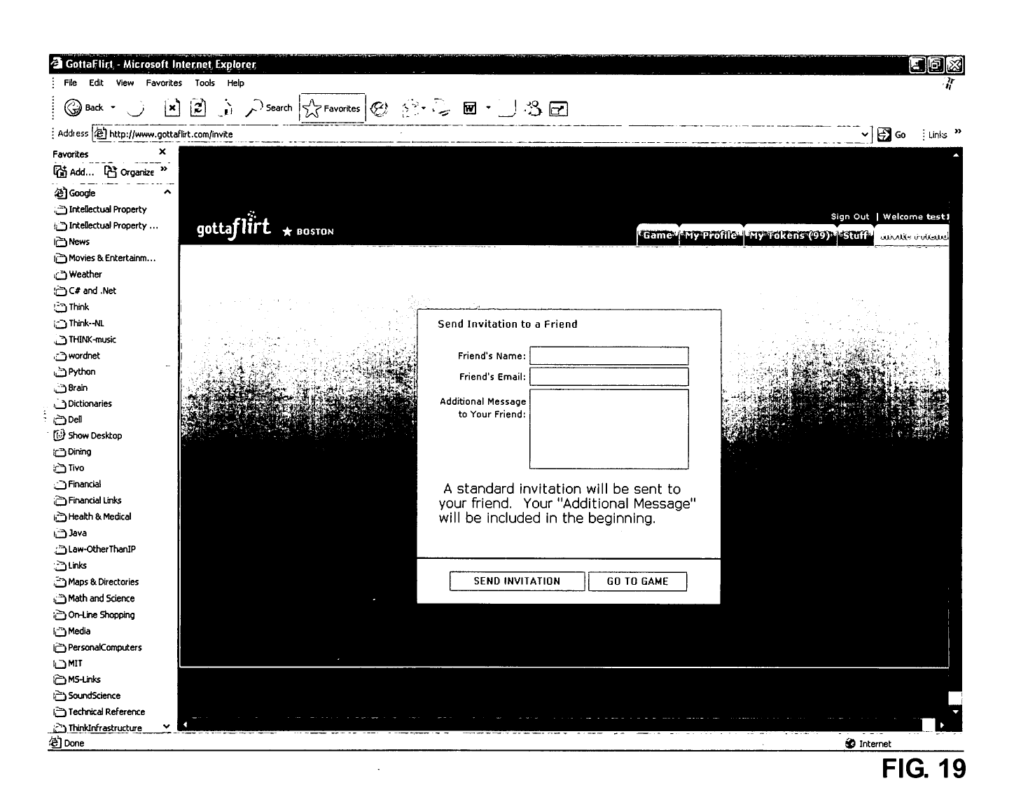

FIG. 19 illustrates the “invite friend” page of the web site which allows a user to send an e-mail to a friend or other person. This can be used by users before, during, or after a game to communicate with other people about participating in the game was another games either as audience members or contestants.

If the user clicks on the market link 706 of a web site or game page, the user will be taken to the market selection page 222 listed in FIG. 2. This is a page that lets the user select which particular markets games it wants to participate in. It is intended that different cities or metropolitan areas will have different game markets in which different games are run simultaneously. In fact, it is intended that even within certain cities or regions different game markets will exist for users of different demographics. For example, there can be different markets for users of different age, of different sexual orientation, or different religious affiliation.

Once a game has been defined and scheduled by a female user, the game definition will be stored in the list of game definitions 338 shown in FIG. 3 and a time at which it has been scheduled will be indicated in a scheduled of games 328 also shown in that figure. The game schedule 328 is monitored by a real-time game server 400 that resides on the server 104 shown in FIG. 1.

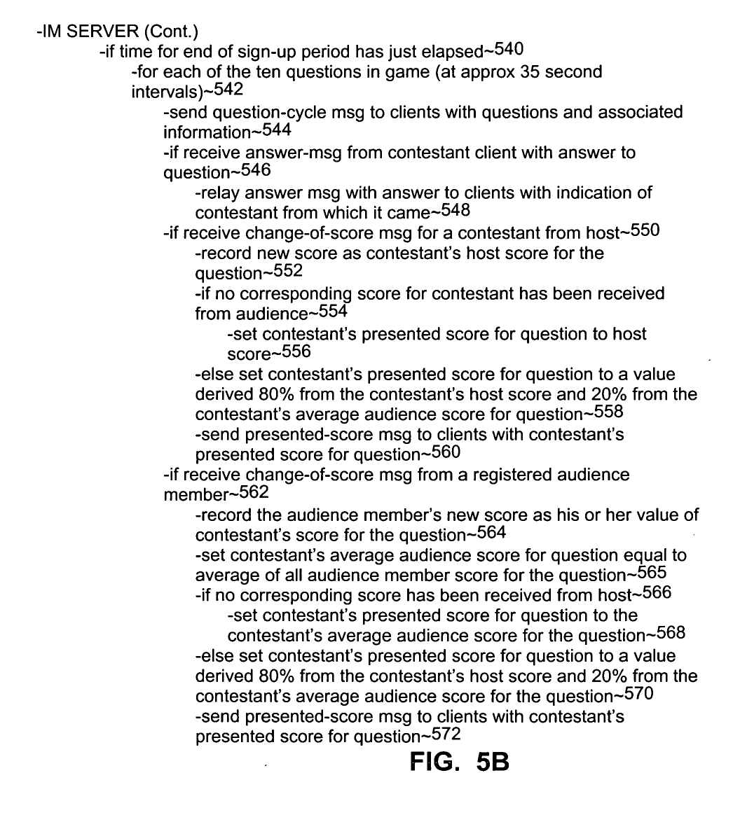

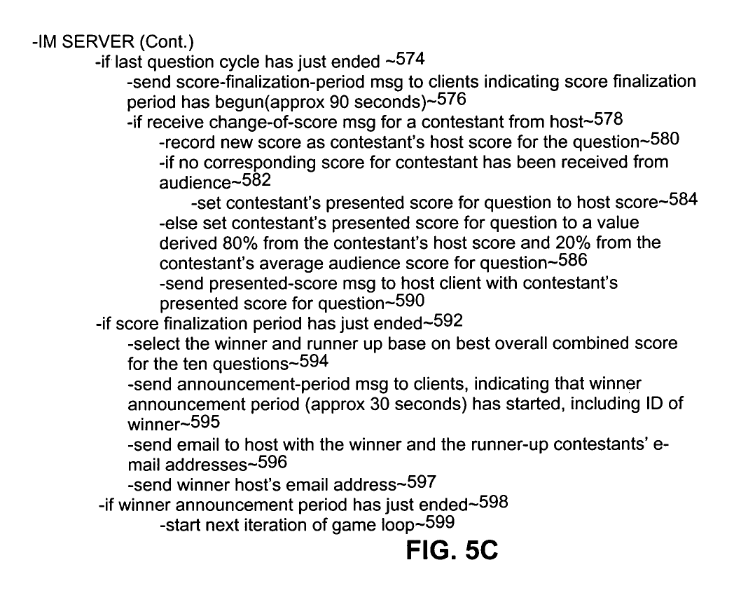

As shown in FIG. four, the game server 400 constantly performs real-time tracking of the game schedule as indicated by step 402. When it detects that it is time for a new game to start steps 404 and 406 cause the game server 400 to send a message to the IM server 500 shown in FIG. 1 and it FIGS. 5A through 5C. This will cause the IM server to conduct the new game.

In embodiments of the invention in which multiple games can be conducted at one time for different markets, a separate IM client can be created for each such market.

FIGS. 5A through 5C provides a simplified pseudocode description of the operation of the IM server 500.

Intended under step 502 are a list of actions which the IM server will take at any time during its normal operation.

If a step 504 detects at any time that the IM server has received a message indicating that a new flash client 108A, shown in FIG. 1, has connected online with the IM server, then step 506 cause is the IM server to send a new-client message to the new client with the current game state if they game is currently underway, or notification about the next scheduled game time if not.

If the flash client 108A receives a message from the IM server indicating that a game is not currently being played in giving the time the next game functions 616 and 618 of the flash client, shown in FIG. 6A, will show the game page within animated clock 702 shown in FIG. seven with text 704 disclosing information about the time of the next scheduled game that has been downloaded with the new-client message from the IM server.

If step 508 detects at any time that a chat message has been received from a flash client at the IM server, step 510 causes the IM server to relay that chat message to all flash client's that are online with it.

As is shown by steps 608 to 614 of FIG. 6A, if a flash client receives input into its chat entry window 708 from a registered user it will send a chat message to the IM server, and if it receives a chat message from the IM server it will display that matches on its chat display window 710.

If step 512 receives a start-game message from the game server 400 shown in FIGS. 1. and four, step 514 causes the IM server to enter the game loop 516 which comprises the remainder of the steps shown in FIGS. 5A through 5C.

The game loop 516 includes instructions 518 through 524 which are performed during the game loop when there is currently not a scheduled game. During such period a loop 520 is performed at a preset frequency to regularly check the game schedule 328 shown in FIG. 3, defined the next scheduled game time, and to send out a next-game message to all the IM server's clients with indication of the next game time to be displayed in the text 704 shown in FIG. seven.

When the IM server starts the game loop in step 514 escapes directly to step 526 of the game loop, shown in FIG. 5A. When this happens steps 528 through 538 are executed.

Step 528 obtains the game definition information for the current game from the list of game definitions 338 shown in FIG. 3. Then a step 530 send a sign-up-period a message to all the flash client's that are online with it indicating that the sign up. For the game, which currently lasts approximately 90 seconds has started. This message includes information on the host of the game including photographs to be displayed on the game page.

Wind in the flash client 108A receives a sign-up-period a message from the IM server step 620 of FIG. 6A causes the block of functions 622 through 632 to be performed. Functions 622 test to see if the cookies on the flash client indicates the user is a registered a male. If so functions 624 through 628 are performed functions 624 displays the “do you want to play” scene, shown in FIG. 20. This scene displays host information downloaded from the IM server, including a sequence of photos of the host shown in a box 2002.

The scene also displays a countdown of the time left in the sign up period by which a user must register if he is to be able to contest in the game for the displayed host. The scene also sounds a tone to draw the users attention to the fact that a new game has started.

If the user selects to play the game by pressing the play button 2004 shown in FIG. 20 step 626 and 628 send a want-to-play message to the IM server requesting to be a contestant and authorizing a charge to the users token account.

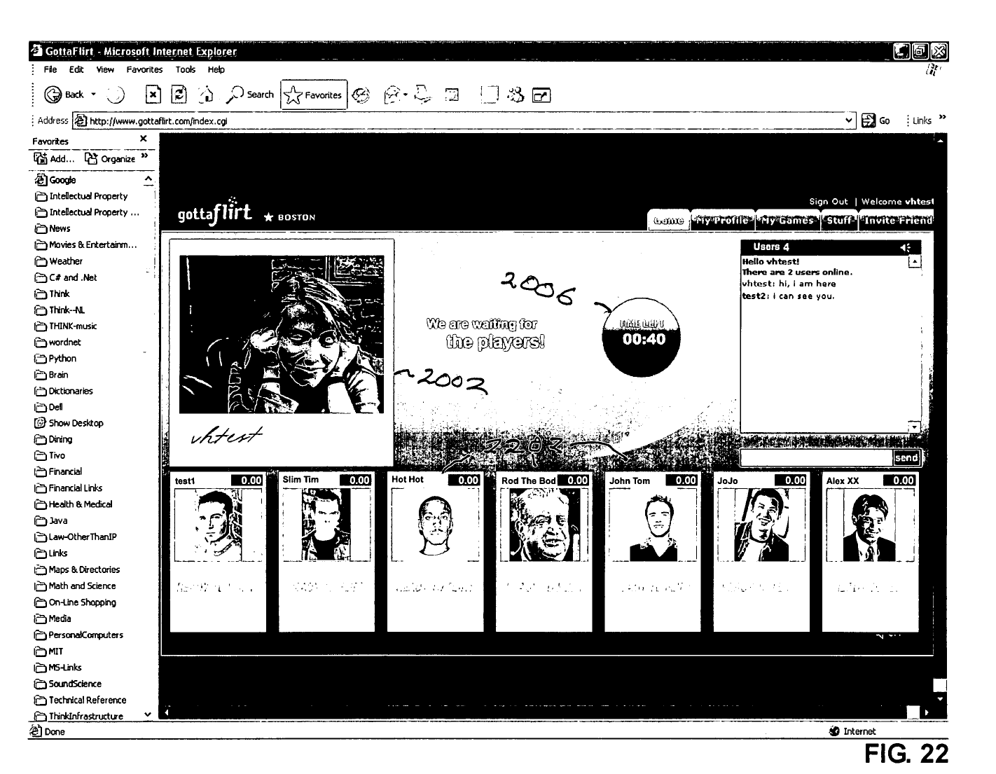

If the flash client that receives the sign-up-period message is that of the host or an audience member step 630 and 632 cause the “waiting for players” scene to be shown. This scene is shown in FIG. 22 with a full complement of contestant display windows 2202. When this window is first displayed by step 632 essence will have yet signed up and none of these windows will be shown to the host display window and the countdown display will be shown in the “waiting for players” window just as it is in the “do you want to play” window.

Referring to FIG. 5A, if it in the IM server receives a want-to-play message from a flash client belonging to a registered mail step 523 causes steps 534 through 538 to be performed. The steps check to see if the male has enough tokens in his token account for 26 in the database 300, of FIG. 3, to pay the price of joining the game and if there's currently room for one more contestant in the game. If these conditions are met the IM server charges the users token account for the price of the game and send say new-contestant message to all the flash client's with information on the new contestant and informing them that he is a contestant.

I shown in FIG. 6A when a flash client receives such a new-contestant message from the IM server, it adds the new contestant's information display to the client's representation of the game state and displays it in all scenes from that time until the end of the game which display the contestants. This enables other men who have not yet registered to play to see the number and identity of contestants in their “do you want to play” scene. It also enables the host and audience members to see the currently registered contestant's as they sign up in the “waiting for players” scenes on their flash clients.

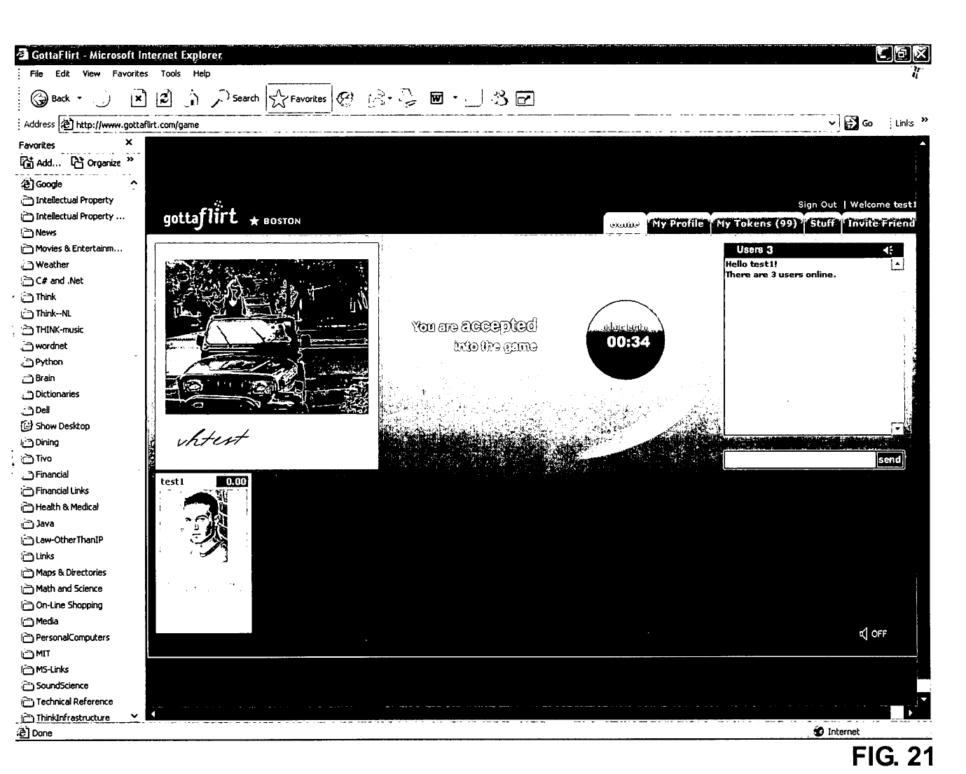

If the new-contestant message indicates that the current flash client's user is the new contestant, step 638 causes steps 640 through 644 to sound a tone, and display a “you are accepted” flash scene, such as that shown in FIG. 21 for a limited number of seconds. This scene informs the user that he is been accepted as a contestant and like the scenes described in the paragraph above, adds his information in the display of contestants. If there is enough time after the brief display of the “your are accepted” scene, steps 642 and 644 change the new contestants of the type shown in FIG. 22.

FIG. 22 shows the “waiting for players” scene after the web sites current when it a seven contestants have enrolled.

Referring to FIG. 5B, when the IM server detects the time for the end of the signup. Has just elapsed step 540 at causes the loop 542 to start. This loop iterates through steps 544 through 572 for each of the 10 questions previously defined by the host for the current game.

Step 544 of this loop sends a question-cycle message to all the clients with the current questions, their associated multiple-choice answers, and the default scores for those choices.

When a flash client receives such a question-cycle message from the IM server step 646 causes steps 648 through steps 670 to be performed. Step 648 loads the information contained in the question-cycle message into the representation of the current questions cycle in the game state representation 109 shown in FIG. 1 for the flash client. Then step 650 displays the question-cycle scene, including a window for displaying a sequence of the host photos and information window for each of the contestants. It also sounds a tone at this time the indicates the start of a new questions cycle.

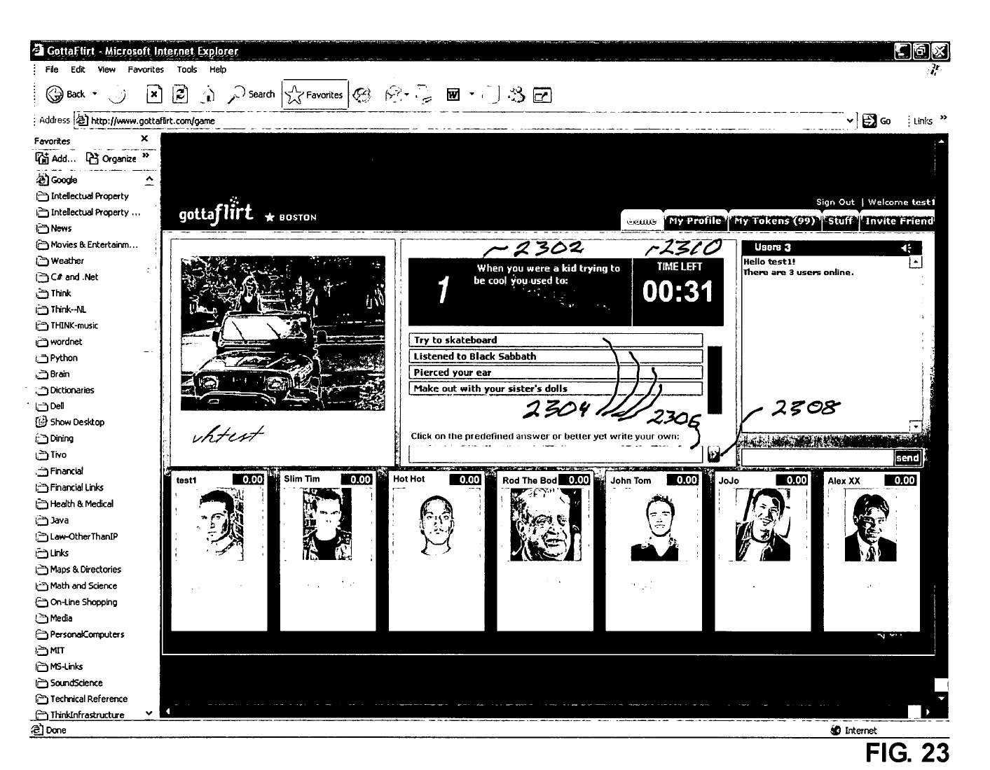

FIG. 23 is a screenshot of the questions cycle scene presented by contestant flash clients for the first question in the game illustrated in FIG. 20 through 28. It contains a question window 2302 which displays the current question. It also includes a list of the multiple-choice answers 2304 that have been prewritten for the question as well as an edit field 2306 in which the user can type and original answer to the current question and selects to transmit that answer by pressing the send button 2308. It also includes a countdown window 2310 then indicates the amount of time left during the current game cycle to answer the current question.

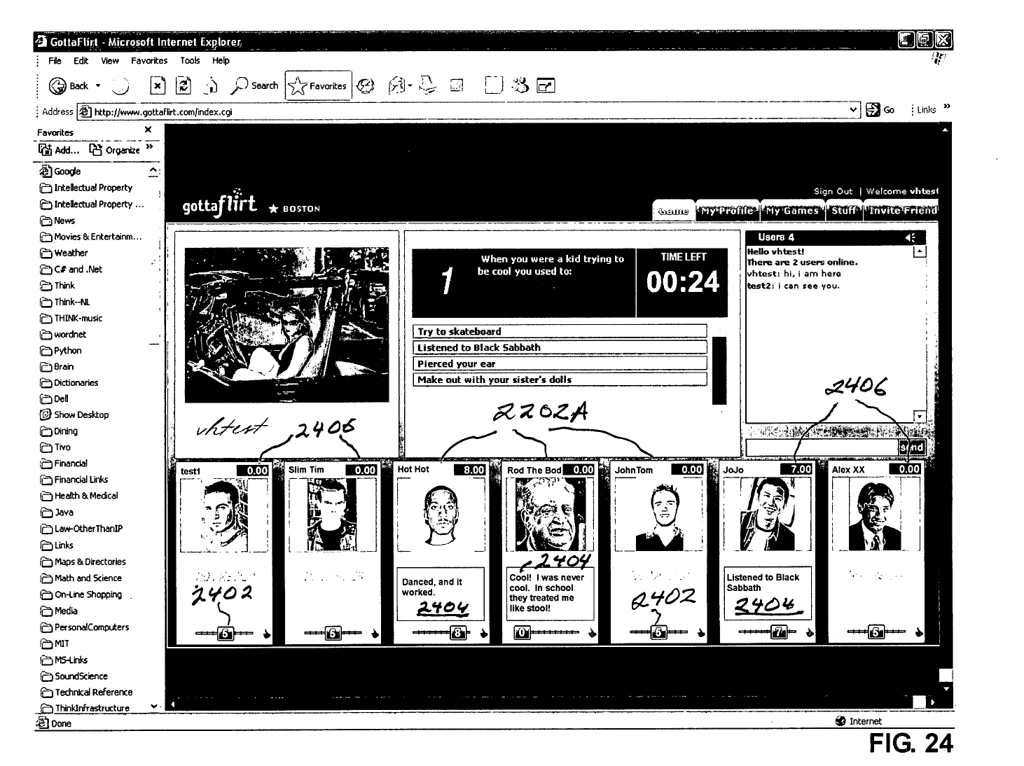

FIG. 24 is a screenshot of the questions cycle scene presented by the flash clients of the host and audience members. It is similar to the scene shown on the contestants flash clients, except for two things. First, it does not contain the edit field 2306 and the corresponding send box 2308, since the host and the audience members do not answer the game's questions. Second, as indicated by function 652 and 654 of FIG. 6A, each of the contestant windows 2202A shown in the contestant windows on host and registered audience member's question cycle scenes contain scoring sliders 2402. These are used to let the host and registered audience members input scores for answers made by individual contestants to the current question.

If a client receives an answer from a contestant in the question cycle steps 656 and 658 send an answer message to the IM server which includes the text of the answer and be against the of the contestant making it.

As is shown in FIG. 5B, if the IM server receives an answer message from the contestant's flash client steps 546 and 548 relay the answer message to all the clients.

As a shown in FIG. 6A if any flash client receives an answer message relayed by the IM server steps 660 and 662 display the answer in the window of the contestant who made the answer. In FIG. 24 such answers are labeled 2404.

If a host or registered audience member makes a change to this setting of the score slider 2402 associated with a given contestant, a change of square message will be indicated within their flash client. If a flash client receives such a change in score, steps 664 and 660 send a change-of-score message to the IM server with the new score and the identity of the user from which it came.

As shown in FIG. 5B, when the IM server receives such a change-of-score message from a host step 550 causes steps 552 through 560 to be performed.

Step 552 records the message's new score as the host score for the message is associated question and contestant. Then step 554 checks to see if there's any corresponding score for the same question and contestant that has been received from any audience members. If not step 556 sets a score called the “presented score” equal to the value of the host score for the message and contestant. Otherwise step 558 calculates the presented score as being equal to a value derived 80% from the host score and 20% from the average audience score for the given question and contestant. Once the calculation of the presented score has been made in response to the change-of-score message, step 560 sends a presented-score message to all the clients for the given contestant and question.

If, on the other hand, a change-of-score message is received from rate registered audience member step 562 causes steps 564 through 572 to be performed.

Step 564 records the new score in association with the audience member from which it came the current question and the contestant for which the score with me. Then step 565 sets the average audience score for the question and contestant equal to the average of all audience member scores for that contestant and question. Then step 566 tests to see if any corresponding score has been received from the host for the same question and contestant. If not step 568 sets the presented score for the contestant and question to the average audience score for the same contestant and question. Otherwise step 570 uses the same formula described above with regard to step 558 to determine the presented score once the presented score has been calculated in this way step 572 sends the presented score in a presented-score message to all the flash clients that are online for the game.

As shown in FIG. 6A if a client receives a presented-score message from the IM server steps 668 and 670 cause the display presented score to be shown in the score window 2406 of the associated contestant. Such score windows are labeled in FIG. 24.

As is shown in FIG. 5A once the time allowed for the last question cycle has elapsed, step 574 causes steps 576 through 590 to be performed.

Step 576 sends a score-finalization-period message to the flash clients indicating that a score finalization period of approximately 90 seconds has begun. During this time the host can review and alter the scores she has given each contestant for each question, and only she can change scores.

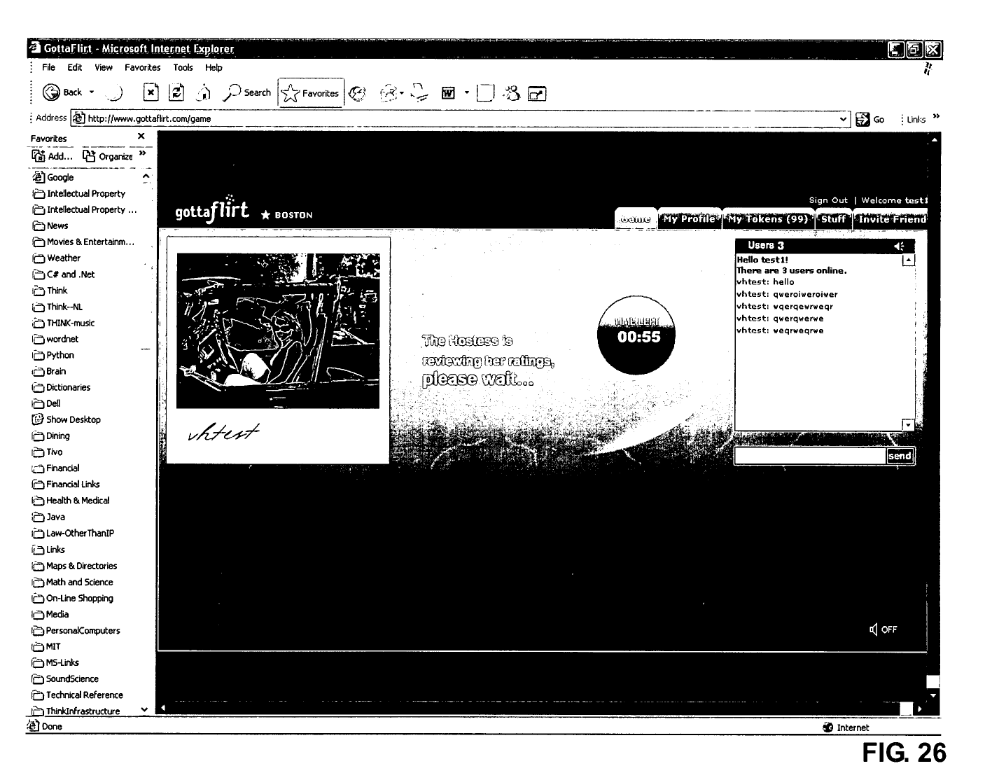

As is shown in FIG. 6B, if a score-finalization-period message is received from the IM server by a flash client other than the host steps 672, 674, and 676 will cause the nod-host score-finalization-period scene to be displayed, such as that shown in FIG. 26, along with a tone announcing the associated change in game state.

If a score-finalization-period message is received by the host's flash client steps 672, 678, and 680 display the host version of the score-finalization-period scene.

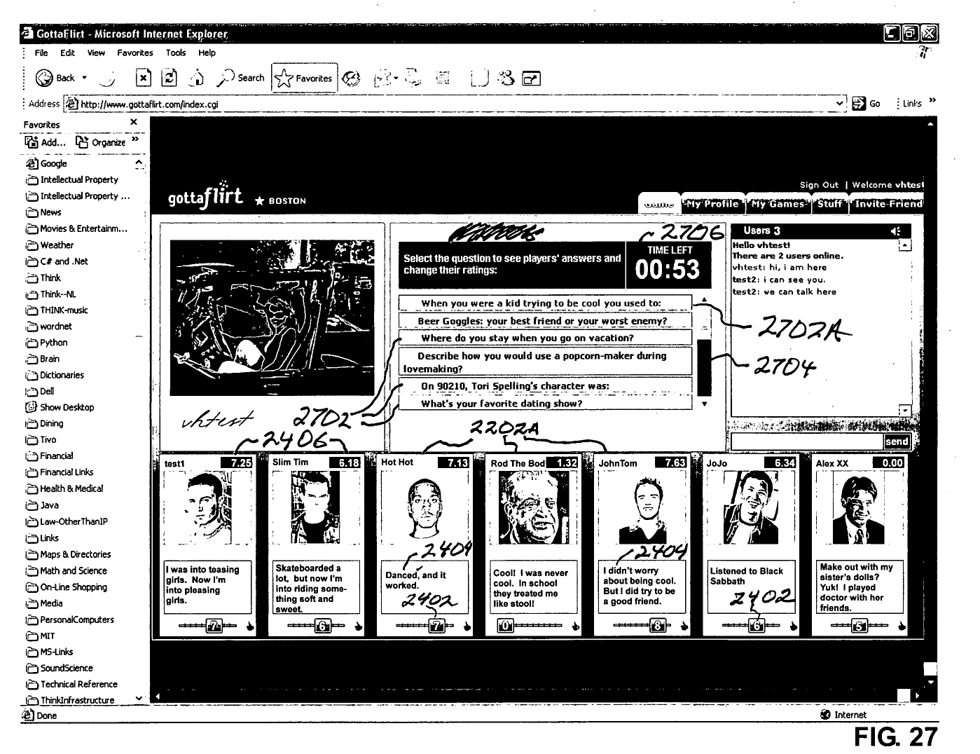

As is illustrated in FIG. 27 this scene allows the user to score any answer to any question made by any contestant during all 10 cycles of the current game. It contains a list of all the games can question each presented in a selectable box 2702. The list can be scrolled with a scroll bar 2704 so that anyone other 10 questions can be seen and selected. The selected question, which in the example shown in FIG. 27, is question 2702A has all of its associated answers by each contestant displayed in that contestant window in this scene. The user can use the scoring sliders 2402 to change any of her prior scores.

If the host makes a change in the position of such a score slider steps 682 and 684 of FIG. 6B will cause a change-of-score message to be sent to the IM server which identifies the new score and the contestant and question for which it is been made.

As is indicated in FIG. 5C when the IM server receives such a message functions 578 through 590 performed functions equivalent to that described above with regard to functions 550 through 560 in FIG. 5B. That is, they calculate a new presented score taking into account the average audience score, if any, previously calculated for the same question and contestant. The only difference is that they only send their presented-score message to the host flash client, since the host is the only person who sees display of scores at this time.

Returning now to FIG. 6B, Windy host's flash client receives such a presented-score message from the IM server steps 686 and 688 display the new presented score in the score window 2406 of the associated contestant so the host can see the effect for changes in score are having on the presented score for the given contestant and question.

As shown in FIG. 5C, when the time for the score finalization has elapsed, functions 592 causes the IM server to performed functions 594 through 597.

Functions 594 selects the winter and runner-up of the current game based on their overall scores over all 10 questions. Then step 595 cents an announcement-period message to all the clients indicating that the winter announcement period, which last approximately 30 seconds has started. This message includes a dedication of the winter. Then steps 596 sends an e-mail to the host with the e-mail addresses of both the winner and the runner-up. Finally step 597 sends the host e-mail address to the winner.

Returning to FIG. 6B, when a flash client receives an announcement-period message from the IM server with identification of the winner, steps 670 causes steps 672 through 676 to be performed.

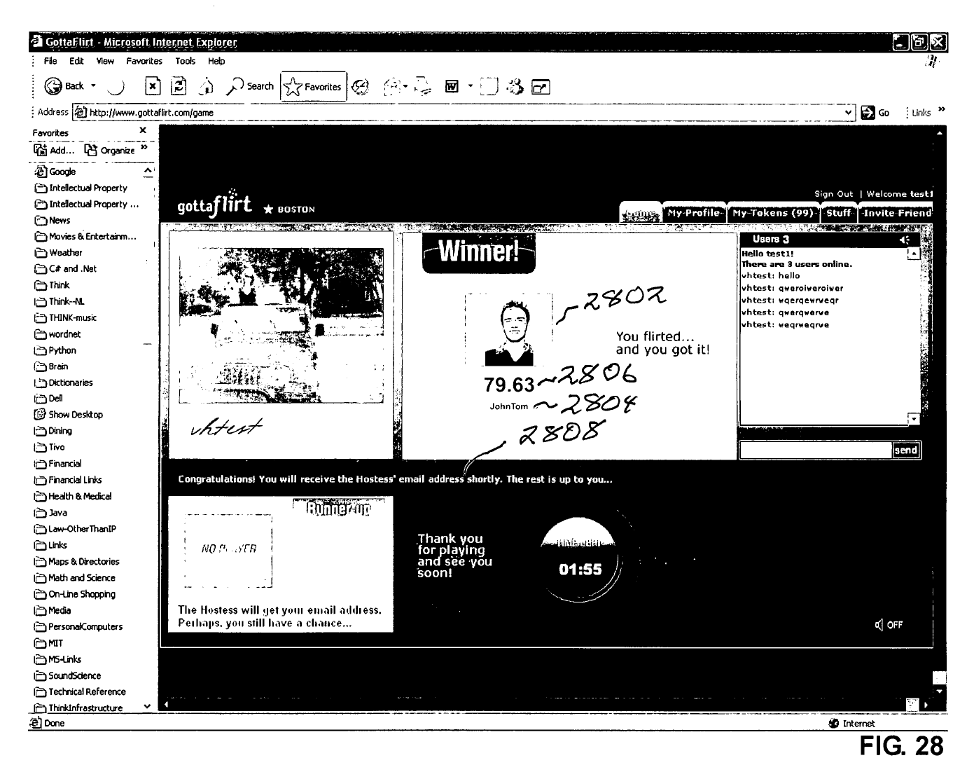

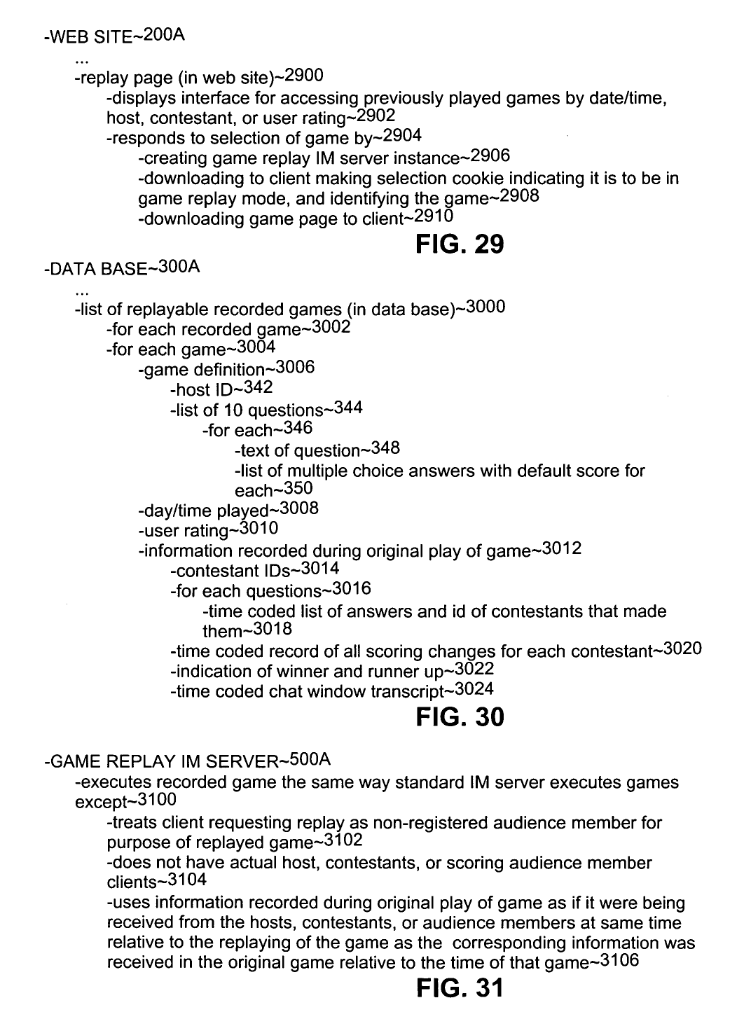

Step 672 displays a winner-announcement scene, which sounds a tone shows information about the winner. Such a scene is shown in FIG. 28. It displays a photograph 2802 of the winner, along with his nickname 2804 and his total score 2806.

Steps 674 and 676 display a line of text on this scene that varies depending on the identity of the flash client's user. For example, on the winner's screen it displays the words “congratulations! You will receive the hostess's email address shortly. The rest is up to you . . . ” And on the host's screen the text line reads “We hope that was fun! You will receive the winner's and the runner up's email shortly.”

What we claim is:

1. A computerized method for conducting a real-time network-based dating game, where each of a plurality of players, including a host and a plurality of contestants, interact through a respective one of a set of computers that are connected via a computer network, said method comprising the steps of:
receiving input from a host representing a selection of one or more competitive challenges for said contestants to perform and using said selection in defining a game associated with the host;
receiving input from potential contestant's indicating a selection to be contestants in a given game defined by a given host;
presenting on each of said contestant's computers simultaneously:
each of the one or more challenges selected by the given host to be part of the given game; and
a user interface for receiving input from the contestant that enables the contestant to compete in the challenge;
presenting in real time on the host's computer the responses of the contestants to each challenge;
receiving any score input by the host in response to each of the contestants' responses;
presenting on the contestant's computer each of the other contestant's response to one or more of said challenges and the score the host has given each of the contestant's responses to said one or more challenges.
A method as in claim x wherein said method further includes;
selecting a winner as a function of the scores given by the host to each of the contestants' responses to the one or more challenges; and
providing a reward to the winner.
A method as in claim x wherein said reward includes the provision of communication access to the host.
A method as in claim x wherein reward includes the provision of the host's email address.
A method as in claim x wherein the host is a female and the contestants are male:
A method as in claim x wherein the host is a male and the contestants are female:
A method as in claim x wherein the host and contestants are of the same sex.
A method as in claim x wherein the challenges are questions and the responses are answers to such questions.
A method as in claim x wherein either said questions or answers, or both, are in the form of spoken words and an audio representation of those spoken words are communicated to other players in real time.
A method as in claim x wherein:
the contestants answer questions by voice;
answers from other contestants are prevented when an answer from a contestant is currently being received; and
the host and other contestants hear the responses in real time.
A method as in claim x further including the step of limiting the time for answering each question to one minute or less.
A method as in claim x further including the steps of:
receiving input from one or more people over the internet concerning a game defined by a given host;
responding to said input by scheduling when the game defined by the given host is to be played;
automatically causing the game to start at the scheduled time.
A method as in claim x wherein the input responded to by said scheduling includes input selecting available time slots from the host.
A method as in claim x wherein:
said method includes providing an interface over the internet that:
lets people see information about one or more potential hosts, including photographs; and
receives rating input from people rating individual hosts; and
said input responded to by said scheduling, includes at least said rating input.
A method as in claim x wherein said method further includes providing an interface over the internet that:
lets people see information about one or more potential hosts; and
information about when a game for a particular host is scheduled to be played.
A method as in claim x further including the step of providing a simultaneously viewable chat window on player computers so players can send and receive messages to and from said chat window during game.
A method as in claim x wherein said chat window provides text messaging.
A method as in claim x wherein said chat window provides audio messaging.
A method as in claim x wherein said chat window provides video messaging.
A method as in claim x further including:
presenting information relating to said game on one or more computers connected with said computer network that are associated with audience members, who are people other than players;
wherein:
said information presented includes said challenges, the contestants' responses, the host's scoring of said responses, and said chat window;
said presentation of said information on said audience computers is performed simultaneously with its presentation to a plurality of the players; and
said chat window allows audience members to interact with players and other audience members by sending and receiving messages.
A method as in claim x wherein said receiving of inputs from a potential contestant indicating a selection to be a contestant includes receiving input authorizing a financial payment to be made from said potential contestant's account as the price of playing said game.
A method as in claim x wherein:
said receiving of input authorizing a payment of the price of playing said game includes receiving competitive bids to be one of a limited number of contestants; and
said method further includes:
providing on the potential contestant's computer an indication of the price that needs to be matched to win a right to be one of said contestants; and
responding to input from the potential contestant authorizing the payment of a monetary amount sufficient to win the bidding by:
enrolling the potential contestant as a contestant in the game; and
causing a transfer of said authorized amount from the potential contestant's account.
A method as in claim x further including the step of automatically transferring at least a portion of money generated by the bidding of said winning contestants to said host or a recipient of selected by the host.
A method as in claim x wherein one or more of said players' respective computers are cell phones, and said computer network is a cellular phone network.
presenting a current game state to a user through said user interface;
responding to a user input received by said user interface during the current game state;
sending and receiving messages using the IM protocol, including:
generating IM control messages, which are IM messages that contain computer generated text in a form that can be parsed as coded instructions;
transmitting said IM control messages to another computer;
receiving said IM control message from one or more other computers;
parsing said message into one or more fields; and
using the values of said fields to control the program flow in the execution of said programming;
wherein said programming further includes instructions for causing:
user input made in response to a current game state on one computer to cause the generation and transmission of said IM control messages; and
receipt of said IM control messages from one or more other computer to cause automatic changes in the game state on the receiving player computer.
A method as in claim x wherein:
said programming running on each of said players' computers includes an IM client for sending and receiving said IM control messages;
said method further includes running an IM server program on a server computer, which server computer:
maintains a representation of a current game state in the server computer;
responds to changes in said server's representation of the current game state by generating and transmitting over said network to the IM clients on one or more of said player computers IM control messages that cause said automatic changes in the representations of current game state on said player computers;
receives IM control messages generated by said IM clients; and
responds to values of fields parsed from said received IM control messages by changing said server's representation of the current game state.
A computerized method for conducting a real-time network-based game, where each of a plurality of players and each of a set of audience members interact through a respective one of a set of computers that are connected via a computer network, said method comprising the steps of:
running user interface programming on each of said player's computer that provides output to and receives input from players of the game;
running user interface programming on each of said set of audience member that:
provides a real time representation of the output and input to one or more of said players; and
receives input from one or more audience members; and
automatically determining the course of said game in response to said input from both said players and audience members.
A method as in claim x wherein said inputs from the audience are scores and said automatically determining the course of the game automatically uses scores from the audience in determining the winner of the game.
A method as in claim x wherein:
said players include a host and a plurality contestants;
said user interface programming on the plurality of contestant computers simultaneously presents each of the one or more competitive challenges selected by the host and received player input generated in response to said challenge;
said user interface programming on the host's computer includes instructions for:
presenting in real time the responses of the contestants to each challenge;
receiving a score from the host in response to each of the contestants' responses;
wherein said automatic determining of the course of said game automatically combines both said scores from the host and scores from the audience in determining the winner of the game.
A method as in claim x wherein:
said challenges are individual questions, and said responses from the players are answers to said individual questions; and
scores from both the host and said audience members are scores made in response to said answers to individual questions.
A method performed by computing machinery of conducting a real-time network-based game where each of a plurality of players, including a host and a plurality contestants, interact with a respective one of a set of computers that are connected via a computer network, said method comprising the steps of:
receiving from the host a selected set of questions;
sequentially performing a question cycle for each of said questions, which includes:
presenting the cycle's question to each contestant and receiving a response to said question;
presenting in real time to the host and all other contestants each of said responses, with an identification of the contestant who made each response;
receiving from the host a score for each of one or more of said responses, which score is associated with both the response and contestant who give the response; and
for each of said scores received from the host, presenting to all players a presented score, determined as a function of said score received from the host, which presented score indicates the contestant with whom its response is associated;
calculating a total score for each contestant as a function of the combination of scores given to the contestant's responses by the host, and using the total scores calculated for all contestants in selecting a winner of the game; and
presenting to all players the total scores of the contestants and an indication of the winner of the game.
A method as in claim x wherein:
one or more audience members each have a computer connected via said network to said player computers;
said presenting of a question cycle's question, the responses to said question, said presented scores, and the indication of the winner, includes presenting said information to said audience members; and
said method further includes:
receiving, during each question cycle, scores from individual audience members for individual responses made by contestants; and
combining scores for a given response from audience members with the score for the same response from the host to calculate the presented score for that response.
A method as in claim X wherein:
said selected set of questions is received before said question cycles are performed; and
each of said question cycles successively automatically presents a question from said pre-selected set of questions.
A method as in claim X wherein:
each of said question cycles has an associated time limit after its presentation of under minute; and
a response to a question after the time limit for its question cycle has expired will not be eligible to receive a score from a host.
A method as in claim X further including:
presenting one or more pictures of the host on player computers;
presenting one or more pictures of each contestant on player computers;
wherein said presentation of contestant scores presents said scores in a manner that spatially associates the score of an individual contestant with a picture of said contestant.
A computerized method for conducting a network-based dating game, where each of a plurality of players, including a host and a plurality of contestants, interact through a respective one of a set of computers that are connected via a computer network, said method comprising the steps of:
running user interface programming on the host's computer that contains instructions for allowing the host to select a one or mores challenges for contestants;
running user interface programming on a potential contestant's computer that contains instructions for:
presenting information, including one or more pictures of the host;
responding to a selection to pay the price to play a game before the host by initiating:
a transfer of funds from an account associated with potential contestant; and
selection of said potential contestant as a contestant for the game before the host;
running user interface programming on each contestant's computer that contains instructions for:
presenting each of said challenges selected by the host for his/her game to each of the contestants;
receiving responses from the contestant in response to each challenge;
presenting responses from a plurality of said contestants to an individual challenge and the scores generated for such responses; and
indicating as the winner of the game the contestant with the best overall score.
A method as in claim x wherein:
said challenges include individual questions, and said responses received from the players are answers to said individual questions
said method further includes running user interface programming on the host's computer that includes instructions for;
responding to an answer to a question by an individual contestant by presenting the players' response; and
receiving a score input by the host in association with said player's answer.
A method as in claim x wherein said programming running on said potential contestant's computers includes programming for presenting a bidding interface that enables the potential contestant to competitively bid to be one of a limited number of contestants, said bidding interface programming including instructions for:
providing an indication of the price that needs to be matched to win a right to be one of said contestants; and
responding to input from a potential contestant authorizing the payment of a monetary amount sufficient to win the bidding by:
enrolling the potential contestant as a contestant in the game; and
causing a transfer of said authorized amount from the potential contestant's account.
A method as in claim x further including the step of automatically transferring at least a portion of money generated by the bidding of said winning contestants to said host or a recipient selected by the host.
A method as in claim x wherein:
said contestants compete against each other at one time
said presenting of each of said challenges to each contestant is performed simultaneously;
said presenting of all responses to an individual challenge and their associated scores are presented in real time.
A method as in claim x wherein:
said challenges are questions and the responses are answers to such questions;
the answers to said questions are presented to other contestants in real time so individual players can alter their answers to take into account answers to a given question that may have been already made by another players.
A computerized method for conducting a real-time network-based dating game, where each of a plurality of players, including a female host and a plurality of male contestants, interact through a respective one of a set of computers that are connected via a computer network, said method comprising the steps of:
running user interface programming on each of a plurality of potential contestant's computers containing instructions for:
presenting information about the host;
receiving input indicating a potential contestant has selected to be a contestant in a game for the host;
running user interface programming on each of said contestant's computers containing instructions for:
representing the current state of a game;
receiving input from the contestant that alters the contestant's in the current state the game;
running on the host's computer user interface programming including instructions for:
representing the current state of the game;
presenting an indication of the relative performance of multiple contestants in the game at successive times in the progress of the game, including, when the game is over, which of the contestants is the winner.
A method as in claim x wherein said information presented about the host on said potential contestant's computer includes one or more pictures of the host.
A method as in claim x wherein said receiving of input indicating a potential contestant has selected to be a contestant includes receiving input authorizing payment of money as the price for becoming a contestant.
A method as in claim x wherein:
said programming running on said potential contestant's computer includes programming for presenting a bidding interface that enables the potential contestant to competitively bid to be one of a limited number of contestants, said bidding interface programming including instructions for:
providing an indication of the price that needs to be matched to win a right to be one of said contestants; and
responding to input from a potential contestant authorizing the payment of a monetary amount sufficient to win the bidding by:
enrolling the potential contestant as a contestant in the game; and
causing a transfer of said authorized amount from the potential contestant's account.
A method as in claim x wherein:
said programming running on said contestant's computer includes instructions for:
receiving bids of financial value from the contestant; and
indicating which bid is the currently highest bid, and ultimately which contestant is the winning bidder; and
said programming running on said host's computer includes instructions for indicating which contestants have made which bids, which bid is the currently highest bid, and ultimately which contestant is the winning bidder; and
said method further includes charging an account of the contestant who was the winner bidder an amount corresponding to the winning bid.
A method as in claim x further including the step of automatically transferring at least a portion of money generated by the winning bid to said host or a recipient of selected by her.
A method as in claim x wherein programming running on said contestant's computer includes instructions for receiving input that allows the user to authorize payment for a gift to the host or to a recipient selected by the host.
Programming for a networked computer game recording in machine readable memory, including player programming for use in a given player's computer during a real-time distributed network game, where each of a plurality of said player computers interact over a computer network, said player programming comprising instruction for:
maintaining a representation of a current game state in the player computer;
generating and transmitting over said network to other computers involved in the running of the game IM control messages that are IM messages containing computer generated text in a form that can be parsed into one or more fields having values that can be used to alter the execution flow in the running of programming used by computer involved in the game;
receiving from other computers over the network said IM control messages involved in the game;
parsing said received IM control messages into said one or more fields;
responding to the values of fields parsed from received IM control messages by automatically changing the player computer's representation of the current game state;
presenting to the player a representation of the current game state;
responding to player input made during the current game state by generating an IM control message and transmitting it over said network to another computer involved in said game.
Computer game programming as in claim x wherein:
said player programming includes an IM client for said sending and receiving of IM control messages; and
said programming for a networked computer game further includes IM server programming for use on a server computer, which server programming includes instructions for:
maintaining a representation of a current game state in the server computer;
responding to changes in said server's representation of the current game state by generating and transmitting over said network to the IM clients on one or more of said player computers IM control messages that cause said automatic changes in the representations of current game state on said player computers;
receiving IM control messages generated by said IM clients; and
responding to values of fields parsed from said received IM control messages by changing said server's representation of the current game state.
A method as in claim x wherein said IM server uses the Jabber IM protocol.
